(19) United States
(12) Patent Application Publication
(10) Pub. No.: US 2006/0035179 A1
(43) Pub. Date: Feb. 16, 2006

(54) Photothermographic material and image forming method using same

(75) Inventor: Takayoshi Oyamada, Kanagawa (JP)

Correspondence Address: TAIYO CORPORATION, 401 HOLLAND LANE, #407, ALEXANDRIA, VA, 22314, US

(73) Assignee: FUJI PHOTO FILM CO., LTD.

(21) Appl. No.: 11/197,596

(22) Filed: Aug. 5, 2005

(30) Foreign Application Priority Data
Aug. 12, 2004 (JP) 2004-235186

(51) Int. Cl. G03C 1/00

(52) U.S. Cl. 430/619

(57) ABSTRACT

A photothermographic material, including a support having an image forming layer on or above one surface thereof and a non-photosensitive layer on or above the opposite surface thereof, the image forming layer containing at least a photosensitive silver halide, a non-photosensitive organic silver salt, a reducing agent, and a binder, wherein: the binder contains 50% by mass or more of a hydrophilic binder; a ratio of a silver amount to the hydrophilic binder in the image forming layer is 1.0 to 2.5 by mass; a binder in the non-photosensitive layer contains 70% by mass or more of a hydrophilic binder; the image forming layer contains at least one of compounds represented by formulae (I) and (II); and a Bekk smoothness is 1000 seconds or more on an outside surface at the side having the image forming layer, while a Bekk smoothness is 5 to 400 seconds on an outside surface at the side having the non-photosensitive layer.

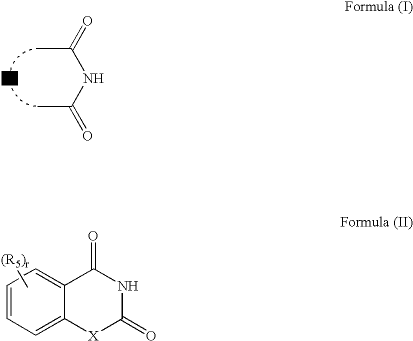

### CROSS-REFERENCE TO RELATED APPLICATION

This application claims priority under 35 USC 119 from Japanese Patent Application No. 2004-235186, the disclosure of which is incorporated by reference herein.

### BACKGROUND OF THE INVENTION

1. Field of the Invention

The present invention relates to a photothermographic material which is excellent in development evenness and in which trouble due to flaws occur scarcely at the time of thermal development, and an image forming method using the photothermographic material.

2. Description of the Related Art

Recently, a decrease in the amount of processing liquid waste has been strongly desired in the medical field in view of environmental conservation and space saving.

Under the circumstances, there is a need for technology relating to photosensitive thermal development photographic materials used for medical diagnosis and photographic technology, which photosensitive thermal development photographic materials can be efficiently exposed by a laser image setter or a laser imager, so that a clear black-toned image having high resolution and good sharpness can be formed.

According to such photosensitive thermal development photographic materials, use of solution-based processing chemicals can be eliminated, and thus a thermal development processing system which is simpler and does not damage the environment can be provided to customers.

Although similar needs also exist in the field of general image forming materials, images for medical use require a high image quality excellent in sharpness and granularity because fine depiction is necessary for medical images, and further, an image of a blue-black tone is desired in view of easy diagnosis.

A variety of hard copy systems including ink jet printers, electrophotographic systems and the like wherein pigments or dyes are applied are widely utilized as general image forming systems. However, these are not satisfactory as a medical image output system.

Thermal image forming systems in which organic silver salts are used have been described in many documents. Particularly, a photothermographic material generally has an image forming layer prepared by dispersing a catalytically active amount of a photocatalyst (e.g. silver halide), a reducing agent, a reducible silver salt (e.g. organic silver salt), and, if necessary, a toner for controlling a color tone of silver into a matrix of a binder. Such a photothermographic material forms a black silver image by being heated to a high temperature (for example, 80° C. or higher) after imagewise exposure to cause an oxidation-reduction reaction between the silver halide or the reducible silver salt (functioning as an oxidizing agent) and the reducing agent. The oxidation-reduction reaction is promoted by a catalytic action of a latent image of the silver halide produced by the exposure. As a result, a black silver image is formed in an exposed region. The Fuji Medical Dry Imager FM-DPL has been put on the market as a medical image forming system using a photothermographic material.

In manufacturing a thermal image forming system wherein an organic silver salt is used, there are two manufacturing methods, one of which is a method of manufacturing by means of solvent coating, and the other of which is a method of manufacturing by applying a coating liquid containing polymer fine particles in an aqueous dispersion as a main binder, and drying the applied coat. The latter method does not require a step for recovering a solvent and the like, and thus, a manufacturing facility therefor is simple, environmental burden is small, and the method is advantageous for mass production.

However, the latter method involves such problems that a film containing a large amount of polymer fine particles is difficult to form into a film shape, and that since moisture disappears from the film at the time of thermal development, physical properties of the film change significantly, whereby cracks appear in its sensitive material or cracks become conspicuous.

Use of a hydrophilic binder such as gelatin or the like has been proposed (for example, see U.S. Pat. Nos. 6,630,291 and 6,713,241, the disclosures of which are incorporated by reference herein). However, thermal development activity of gelatin is low, and when the activity is elevated to attempt to obtain a sufficient image, there is a problem of increased density unevenness, which does not allow for practical use.

### SUMMARY OF THE INVENTION

The present invention provides a photothermographic material having an excellent coated surface state and exhibiting a small amount of fog, and an image forming method using the photothermographic material.

A first aspect of the invention is to provide a photothermographic material, comprising a support having an image forming layer on or above one surface thereof and a non-photosensitive layer on or above the opposite surface thereof,

the image forming layer containing at least a photosensitive silver halide, a non-photosensitive organic silver salt, a reducing agent, and a binder wherein:

the binder contains 50% by mass or more of a hydrophilic binder;

a ratio of a silver amount to the hydrophilic binder in the image forming layer is 1.0 to 2.5 by mass;

a binder in the non-photosensitive layer contains 70% by mass or more of a hydrophilic binder;

the image forming layer contains at least one of compounds represented by the following formulae (I) and (II); and

a Bekk smoothness is 1000 seconds or more on an outside surface of the side having the image forming layer, while a Bekk smoothness is 5 seconds to 400 seconds on an outside surface of the side having the non-photosensitive layer: 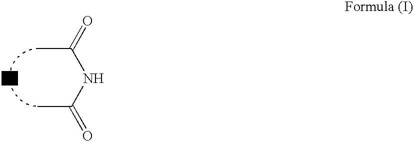
wherein Q represents an atomic group required for forming a 5- to 6-membered imide ring; 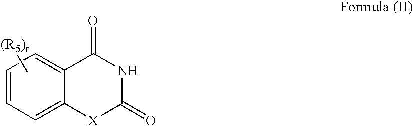
wherein R₅ represents independently a hydrogen atom, an alkyl group, a cycloalkyl group, an alkoxy group, an alkylthio group, an arylthio group, a hydroxy group, a halogen atom, or an N(R₈R₉) group wherein R₈ and R₉ represent independently a hydrogen atom, an alkyl group, an aryl group, a cycloalkyl group, an alkenyl group or a heterocyclic group; r is 0, 1, or 2; R₈ and R₉ may bond with each other to form a substituted or an unsubstituted five- to seven-membered heterocyclic ring; two R₅ groups may bond with each other to form an aromatic, heteroaromatic, alicyclic or heterocyclic fused ring; and X represents O, S, Se or N(R₆) wherein R₆ represents a hydrogen atom or an alkyl group, an aryl group, a cycloalkyl group, an alkenyl group or a heterocyclic group.

A second aspect of the invention is to provide an image forming method comprising developing thermally the photothermographic material according to the first aspect of the invention at a thermal developing linear speed of 20 mm/sec to 50 mm/sec.

A third aspect of the invention is to provide an image forming method comprising developing thermally the photothermographic material according to the first aspect of the invention by a drum development method.

The present inventor has studied the use of a setting type hydrophilic binder such as gelatin as a binder in an image forming layer for a novel photothermographic material in which an excellent coated surface state can be obtained.

Heretofore, a hydrophilic binder has been generally used in a silver halide photosensitive material for a wet developing system. However, when such a binder is applied to a photothermographic material, new problems arise which did not exist heretofore in conventional silver halide photosensitive materials for the wet developing system. A basic problem relating thereto resides in that a development activity of such a photothermographic material decreases extremely, resulting in a low image density and a low sensitivity.

For improving thermal development characteristics, it has been found that decreasing an amount of a hydrophilic binder in an image forming layer, in other words, increasing an organic silver salt/hydrophilic binder ratio, is effective.

Furthermore, it has been found that when a compound having a succinimide group is included in an image forming layer, a thermal development activity thereof is elevated. Hence, when the means for improvement as described above are combined with each other, a high thermal development activity can be expected.

However, there arises an unexpected problem of thermal development cracks as an adverse effect of such means for improving the thermal development activity. The term “thermal development cracks” means innumerable cracks, which are fine but visible, appearing on a surface of a thermally developed image. According to electron-microscopic observation of a section of a developed image, such cracks appearing on the surface extend to the inside thereof.

Although an exact cause is not clear, it is presumed that fine flaws which are not visible and appear on the surface due to some unascertained factor are caused to extend to the inside of the developed image by thermal development, whereby they become visible cracks.

As a result of a factor analysis, it has been found that increasing an organic silver salt/hydrophilic binder ratio results in a worse situation, and further addition of a compound containing a succinimide group results in a remarkably worse situation. Such adverse effects of a succinimide compound could not be predicted, and moreover, such a peculiar phenomenon cannot be understood from posteriori reasoning.

As a result of earnest efforts by the present inventor for solving such newly arisen problems, it has been found that these problems can be solved by adjusting respective Bekk smoothness of an image forming surface and a back surface to within particularly selected ranges, whereby the photothermographic material according to the first aspect of the invention has been achieved.

Moreover, it has been found that a significantly advantageous effect can be attained by an image forming method in which the photothermographic material of the invention is thermally developed at a high linear speed, or in which a thermal development apparatus adopting a drum type heating method is used with the photothermographic material of the invention. As a result, the image forming method according to the second aspect, and the image forming method according to the third aspect have been achieved.

### BRIEF DESCRIPTION OF THE DRAWING

FIG. 1 is a schematic constitutional view showing an embodiment of a thermal development apparatus applied in the present invention.

### DETAILED DESCRIPTION OF THE INVENTION

In the following, the present invention will be described in detail.

1. Method for Manufacturing Photothermographic Material

The photothermographic material of the present invention includes a support having an image forming layer on or above one surface thereof and a non-photosensitive layer on or above the opposite surface thereof. The image forming layer contains at least a photosensitive silver halide, a non-photosensitive organic silver salt, a reducing agent and a binder.

The image forming layer of the invention is formed on or above the support and may be a single layer or plural layers. The image forming layer may contain additional materials such as a toner, a coating additive and other additives according to needs. The non-photosensitive layer of the invention may be a single layer or plural layers.

In the image forming layer in the photothermographic material of the invention, 50% by mass or more of the binder is a hydrophilic binder, a ratio of an amount of silver to that of the hydrophilic binder in the image forming layer is 1.0 to 2.5 by mass, and the image forming layer contains at least one compound having an imide group and represented by the formula (I) or (II).

70% by mass or more of the binder in the non-photosensitive layer is a hydrophilic binder.

Furthermore, a Bekk smoothness is 1000 seconds or more on an outside surface at the side having the image forming layer, while a Bekk smoothness is 5 seconds to 400 seconds on an outside surface at the side having the non-photosensitive layer.

The photothermographic material of the invention preferably contains at least one member selected from polyacrylamids or derivatives thereof. In the non-photosensitive organic silver salt of the invention, particles are preferably formed in the presence of the at least one member selected from polyacrylamides or derivatives thereof.

The non-photosensitive organic silver salt of the invention is more preferably water-washed with an aqueous washing liquid containing the at least one member selected from polyacrylamides or derivatives thereof.

In the invention, the non-photosensitive organic silver salt particles are preferably nanoparticles, and the nanoparticles more preferably have an average particle size of 10 nm to 1000 nm.

In the invention, it is preferable that there is a non-photosensitive layer as the outermost layer on the same side as the image forming layer.

In the invention, the hydrophilic binder in the image forming layer is preferably gelatin or a gelatin derivative.

In the invention, a hydrophilic binder in the outermost layer on the same side as the image forming layer is preferably gelatin or a gelatin derivative.

In an embodiment, as an image forming method, the photothermographic material of the invention is thermally developed at a thermal developing linear speed of 20 mm/second to 50 mm/second to form an image. In another embodiment, thermal development is conducted by a thermal development apparatus adopting a drum development method.

(Organic Silver Salt)

1) Composition

The non-photosensitive organic silver salt used in the invention is an organic silver salt which is relatively stable to light and which supplies a silver ion when heated to 80° C. or higher under the presence of the exposed photosensitive silver halide and the reducing agent, to form a silver image. The organic silver salt may be any organic substance that can be reduced by the reducing agent to provide a silver ion. Such non-photosensitive organic silver salts are described in JP-A No. 10-62899, Paragraph 0048 to 0049, EP-A No. 0803764A1, Page 18, Line 24 to Page 19, Line 37, EP-A No. 0962812A1, JP-A Nos. 11-349591, 2000-7683, and 2000-72711, etc. The disclosures of the above patent documents are incorporated herein by reference. The organic silver salt is preferably a silver salt of an organic acid, particularly preferably a silver salt of a long-chain aliphatic carboxylic acid having 10 to 30 carbon atoms, preferably having 15 to 28 carbon atoms. Examples of the fatty acid silver salts include silver lignocerate, silver behenate, silver arachidate, silver stearate, silver oleate, silver laurate, silver caproate, silver myristate, silver palmitate, silver erucate, and mixtures thereof. In the invention, the proportion of the amount of silver behenate to the total amount of the organic silver salt is preferably 50 to 100 mol %, more preferably 85 to 100 mol %, further preferably 90 to 100 mol %. Further, the ratio of the amount of silver erucate to the total amount of the organic silver salts is preferably 2 mol % or less, more preferably 1 mol % or less, further preferably 0.1 mol % or less.

Further, the ratio of the amount of silver stearate to the total amount of the organic silver salts is preferably 1 mol % or lower so as to obtain a photothermographic material with a low Dmin, high sensitivity, and excellent image storability. The ratio of the amount of silver stearate to the total amount of the organic silver salts is more preferably 0.5 mol % or lower. In a preferable embodiment, the organic silver salts include substantially no silver stearate.

When the organic silver salts include silver arachidate, the ratio of the amount of silver arachidate to the total amount of the organic silver salts is preferably 6 mol % or lower from the viewpoint of achieving a low Dmin and excellent image storability. The ratio of the amount of silver arachidate to the total amount of the organic silver salts is more preferably 3 mol % or lower.

2) Form

An organic silver salt in the invention is preferably in the form of nanoparticles. An average particle size (equivalent sphere diameter) of the nanoparticles is preferably 10 nm to 1000 nm, and more preferably 30 nm to 400 nm.

When an average particle size is less than the range of the invention, and a ratio of an amount of silver to that of the hydrophilic binder is within the range of the invention, a film applied may become fragile, so that cracks in thermal development may become worse, while when it exceeds the range of the invention, a development activity may become worse, resulting in poor sensitivity. Accordingly, it is preferred to use the organic sliver salt having an average particle size within the specified range.

In the invention, an equivalent sphere diameter is determined by photographing directly a sample to be measured by the use of an electronic microscope, and thereafter image-treating the negative photograph to obtain the image to be determined.

A particle size distribution of an organic silver salt is preferably monodispersion. The term “monodispersion” means a percentage of each value obtained by dividing a standard deviation of a length of a minor axis or that of a major axis by the minor axis or the major axis, respectively, is preferably 100% or less, more preferably 80% or less, and still further preferably 50% or less.

A form of an organic silver salt may be determined from a transmission electron microscopic image of a dispersed product of the organic silver salt.

As another method for determining monodispersibility, there is a manner for determining a standard deviation of a volume-weighted average diameter of an organic silver salt wherein a percentage of a value (variation coefficient) obtained by dividing the standard deviation by the volume-weighted average diameter is preferably 100% or less, more preferably 80% or less, and still further preferably 50% or less.

In a specific measuring manner, for example, a laser beam is irradiated on an organic silver salt dispersed into a liquid, an autocorrelation function is determined with respect to changes in time of fluctuation of the scattered light, and a particle size distribution may be obtained from the resulting particle size (volume-weighted average diameter).

3) Preparation

It is preferred that an organic silver salt used in the invention is dispersed by at least one dispersant selected from polyacrylamides and the derivatives thereof.

These dispersants may be added either in case of preparing the organic silver salt, or in case of a dispersing the same. However, the organic silver salt is preferably formed into particles in the presence of these dispersants. More preferable is that a desalination treating step after the particle formation is also conducted in the presence of these dispersants.

In order to form a particle size of the organic silver salt within the above specified range, it is preferred to add the dispersants at the time of forming particles, and more preferable is that the resulting particles are washed with a washing liquid containing the dispersants. A concentration of the washing liquid containing the dispersants used in case of rinsing is preferably 1/100 times higher or more and 100 times higher or less concentration with respect to that used in case of the preparation, and more preferable is that a concentration of the cleaning fluid containing the dispersants used in case of rinsing is 1/10 times higher or more and 10 times higher or less with respect to that used in case of the preparation. In another manner for changing a particle size, it is preferred to vigorously agitate a mixture at the time of reaction.

It is preferred to use a compound represented by either of the following formula (W1) or (W2) as at least one dispersant selected from the polyacrylamides and the derivatives thereof used in the invention: 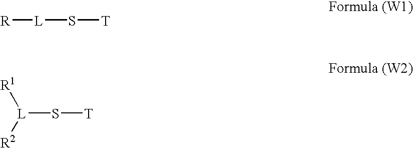
wherein R is a hydrophobic group, at least one of R₁ and R₂ is a hydrophobic group, L is a divalent linking group, and T is an oligomer moiety.

The number of hydrophobic groups is determined dependent on the linking group L, the hydrophobic groups are selected from saturated or unsaturated alkyl groups, arylalkyl groups and alkylaryl groups wherein each alkyl moiety may be a straight chain or a branched chain. The hydrophobic R, R₁, and R₂ have preferably 8 to 21 carbon atoms. The linking group L is bonded to the hydrophobic group(s) with a simple chemical bond(s), and bonded to the oligomer moiety T with a thio (—S—) bond(s). A typical linking group for a material containing one hydrophobic group is represented by italic letters in the following formulae:

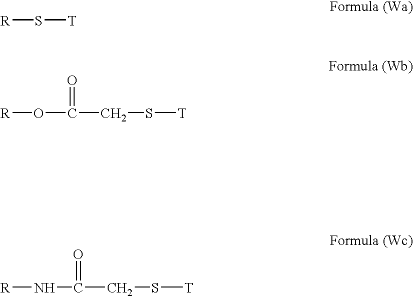

A typical linking group for a material containing two hydrophobic groups is represented by italic letters in the following formulae:

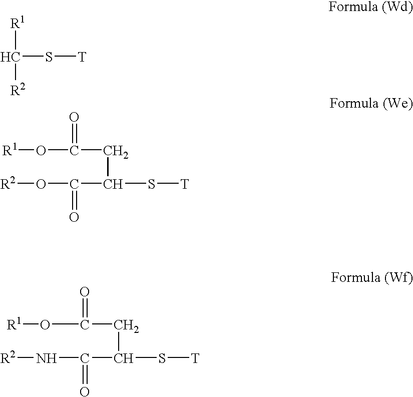

An oligomer group T is a group corresponding to an oligomerization of a vinyl monomer having an amide functional group wherein a vinyl moiety provides a route for the oligomerization, and an amide moiety provides a nonionic polar group constituting hydrophilic functional groups (after the oligomerization). The oligomer group T may be produced from a monomer mixture, when a surface active material obtained by such result that a kind of a monomer source or the resulting oligomer chain becomes sufficiently hydrophilic is dissolved or dispersed into water. Typical monomers used for producing the oligomer chain T are based on acrylamide, methacrylamide, acrylamide derivatives, methacrylamide derivatives, and 2-vinylpyrrolidone. However, the last material is not so preferred because of harmful photographic actions which are observed sometimes by means of polyvinyl pyrrolidone (PVP).

These monomers may be represented by the following two types of formulae:
Acrylamide, methacrylamide 2-Vinylpyrrolidone or the derivatives thereof 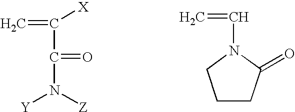
   wherein X is typically H or CH₃, these bring about acrylamide- or methacrylamide-base monomers, Y and Z are typically H, CH₃, C₂H₅, C(CH₂OH)₃, and X and Y may be the same or different from one another.

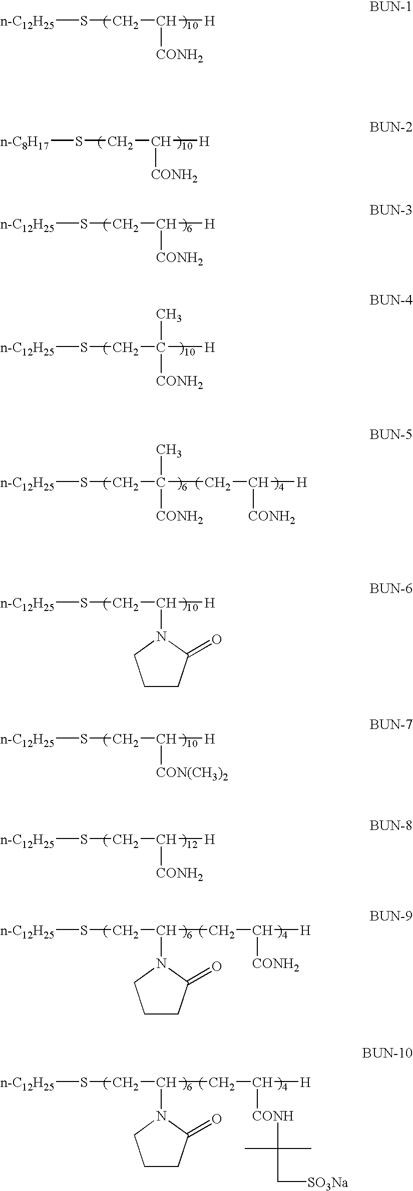

The above-mentioned oligomer surfactant containing, as the major component, a vinyl polymer having an amide functional group may be manufactured in accordance with either a method which is well-known by those skilled in the art, or a simply modified method of such well-known method.

In the following, an example of the methods of those mentioned above will be described. An aqueous base nanoparticle silver carboxylate dispersed material may be produced in accordance with a medium grinding method including the following steps:

(A) a step for preparing a silver carboxylate dispersion material containing silver carboxylate, water as a medium for a carboxylate, and the above-mentioned modifier;

(B) a step for mixing the carboxylate dispersion material with a rigid grinding medium having an average particle diameter of less than 500 μm;

(C) a step for charging a high-speed mill with the mixture in the step (B);

(D) a step for grinding the mixture in the step (C) until a carboxylate particle size distribution wherein 90 mass % of the carboxylate particles have each particle diameter of less than 1 μm is obtained; and

(E) a step for separating the grinding medium from the mixture ground in the step (D).

When the organic silver salt particles are dispersed in the presence of a photosensitive silver salt, the fogging is intensified and the sensitivity is remarkably reduced. Thus, in a preferable embodiment, substantially no photosensitive silver salts are present when the organic silver salt particles are dispersed. In the invention, the amount of the photosensitive silver salts in the aqueous dispersion liquid of the organic silver salt is preferably 1 mol % or less, more preferably 0.1 mol % or less, per 1 mol of the organic silver salt. It is more preferable not to add the photosensitive silver salts to the dispersion liquid actively.

In an embodiment, the photosensitive material is prepared by processes comprising mixing an aqueous organic silver salt dispersion liquid with an aqueous photosensitive silver salt dispersion liquid. The mixing ratio between the organic silver salt and the photosensitive silver salt may be selected depending on the use of the photosensitive material. The mole ratio of the photosensitive silver salt to the organic silver salt is preferably 1 to 30 mol %, more preferably 2 to 20 mol %, particularly preferably 3 to 15 mol %. It is preferable to mix two or more aqueous organic silver salt dispersion liquids and two or more aqueous photosensitive silver salt dispersion liquids so as to adjust the photographic properties.

The organic silver salt may be prepared and dispersed by any of the methods described, for example, in JP-A No. 10-62899, EP-A Nos. 0803763A1 and 0962812A1, JP-A Nos. 11-349591, 2000-7683, 2000-72711, 2001-163889, 2001-163890, 2001-163827, 2001-33907, 2001-188313, 2001-83652, 2002-6442, 2002-49117, 2002-31870, and 2002-107868, the disclosures of which are incorporated herein by reference.

4) Amount

The amount of the organic silver salt may be selected without particular restrictions, and the total amount of the applied silver (including the photosensitive silver halide) is preferably 0.1 g/m² to 5.0, more preferably 0.3 g/m² to 3.0 g/m², furthermore preferably 0.5 g/m² to 2.0 g/m². In order to improve the image storability, the total amount of the applied silver is preferably 1.8 g/m² or less, and more preferably 1.6 g/m² or less. In the invention, when a reducing agent preferred in the invention is used, sufficient image density can be achieved even with such a small amount of silver by using.

(Reducing Agent)

The photothermographic material of the invention preferably includes a heat developing agent that is a reducing agent for the organic silver salt. In the invention, the reducing agent is preferably a so-called hindered phenol reducing agent having a substituent at an ortho position relative to the phenolic hydroxyl group, or a bisphenol reducing agent, particularly preferably a compound represented by the following formula (R).

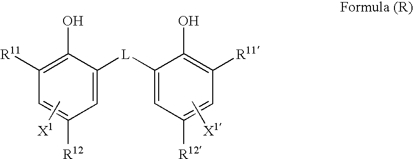

In the formula (R), R¹¹ and R^{11′} each independently represent an alkyl group, and at least one of R¹¹ and R^{11′} is a secondory or tertiary alkyl group; R¹² and R^{12′} each independently represent a hydrogen atom or a substituent which can be bonded to the benzene ring; L represents an —S— group or a —CHR¹³— group, and R¹³ represents a hydrogen atom or an alkyl group; X¹ and X^{1′} each independently represent a hydrogen atom or a substituent which can be bonded to the benzene ring.

The formula (R) is described in detail below.

In the following, the scope of the term “an alkyl group” encompasses “a cycloalkyl group” unless mentioned otherwise.

1) R¹¹ and R^{11′}

R¹¹ and R^{11′} each independently represent a substituted or unsubstituted alkyl group having 1 to 20 carbon atoms, and at least one of R¹¹ and R^{11′} is a secondory or tertiary alkyl group. There are no particular restrictions on the substituents on the alkyl group. Examples of preferred substituents on the alkyl group include aryl groups, a hydroxy group, alkoxy groups, aryloxy groups, alkylthio groups, arylthio groups, acylamino groups, sulfonamide groups, sulfonyl groups, phosphoryl groups, acyl groups, carbamoyl groups, ester groups, ureido groups, urethane groups, and halogen atoms.

2) R¹² and R^{12′}, and X¹ and X^{1′}

R¹² and R^{12′} each independently represent a hydrogen atom or a substituent which can be bonded to the benzene ring. Also X¹ and X^{1′} each independently represent a hydrogen atom or a substituent which can be bonded to the benzene ring. Examples of preferable substituents which can be bonded to the benzene ring include alkyl groups, aryl groups, halogen atoms, alkoxy groups, and acylamino groups.

3) L

L represents an —S— group or a —CHR¹³— group. R¹³ represents a hydrogen atom or an alkyl group having 1 to 20 carbon atoms, and the alkyl group may have a substituent. When R¹³ represents an unsubstituted alkyl group, examples thereof include a methyl group, an ethyl group, a propyl group, a butyl group, a heptyl group, an undecyl group, an isopropyl group, a 1-ethylpentyl group, a 2,4,4-trimethylpentyl group, a cyclohexyl group, a 2,4-dimethyl-3-cyclohexenyl group, and a 2,4-dimethyl-3-cyclohexenyl group. Examples of the substituent on the alkyl group represented by R¹³ include the substituents described above as examples of the substituents on R¹¹. The substituent on the alkyl group may be a halogen atom, an alkoxy group, an alkylthio group, an aryloxy group, an arylthio group, an acylamino group, a sulfonamide group, a sulfonyl group, a phosphoryl group, an oxycarbonyl group, a carbamoyl group, or a sulfamoyl groups.

4) Preferred Substituents

R¹¹ and R^{11′} each are preferably a secondary alkyl group having 1 to 15 carbon atoms, or a tertiary alkyl group having 1 to 15 carbon atoms. Specific examples of such an alkyl group include an isopropyl group, a t-butyl group, a t-amyl group, a t-octyl group, a cyclohexyl group, a cyclopentyl group, a 1-methyl cyclohexyl group, and a 1-methylcyclopropyl group. R¹¹ and R^{11′} each are more preferably a t-butyl group, a t-amyl group, or a 1-methylcyclohexyl group, most preferably a t-butyl group.

R¹² and R^{12′} each are preferably an alkyl group having 1 to 20 carbon atoms, and specific examples thereof include a methyl group, an ethyl group, a propyl group, a butyl group, an isopropyl group, a t-butyl group, a t-amyl group, a cyclohexyl group, a 1-methylcyclohexyl group, a benzyl group, a methoxymethyl group, and a methoxyethyl group. R¹² and R^{12′} each are more preferably a methyl group, an ethyl group, a propyl group, an isopropyl group, or a t-butyl group, particularly preferably a methyl group or an ethyl group.

X¹ and X^{1′} each are preferably a hydrogen atom, a halogen atom, or an alkyl group, more preferably a hydrogen atom.

L is preferably a —CHR¹³— group.

R¹³ is preferably a hydrogen atom or an alkyl group having 1 to 15 carbon atoms. The alkyl group may be a linear alkyl group or a cyclic alkyl group, and may have a C═C bond. The alkyl group is preferably a methyl group, an ethyl group, a propyl group, an isopropyl group, a 2,4,4-trimethylpentyl group, a cyclohexyl group, a 2,4-dimethyl-3-cyclohexenyl group, or a 3,5-dimethyl-3-cyclohexenyl group. R¹³ is particularly preferably a hydrogen atom, a methyl group, an ethyl group, a propyl group, an isopropyl group, or a 2,4-dimethyl-3-cyclohexenyl group.

When R¹¹ and R^{11′} are tertiary alkyl groups and R¹² and R^{12′} are methyl groups, R¹³ is preferably a primary or secondary alkyl group having 1 to 8 carbon atoms such as a methyl group, an ethyl group, a propyl group, an isopropyl group, and a 2,4-dimethyl-3-cyclohexenyl group.

When R¹¹ and R^{11′} are tertiary alkyl groups and R¹² and R^{12′} are alkyl groups other than methyl, R¹³ is preferably a hydrogen atom.

When at least one of R¹¹ and R^{11′} is different from a tertiary alkyl group, R¹³ is preferably a hydrogen atom or a secondary alkyl group, particularly preferably a secondary alkyl group. The secondary alkyl group is preferably an isopropyl group or a 2,4-dimethyl-3-cyclohexenyl group.

The combination of R¹¹, R^{11′}, R¹², R^{12′} and R¹³ affects the heat developability of the resultant photothermographic material, the tone of the developed silver, and the like. It is preferable to use a combination of two or more reducing agents depending on the purpose since such properties can be adjusted by the combination of the reducing agents.

Specific examples of the reducing agent usable in the invention (such as compounds represented by the formula (R)) are illustrated below without intention of restricting the scope of the invention.

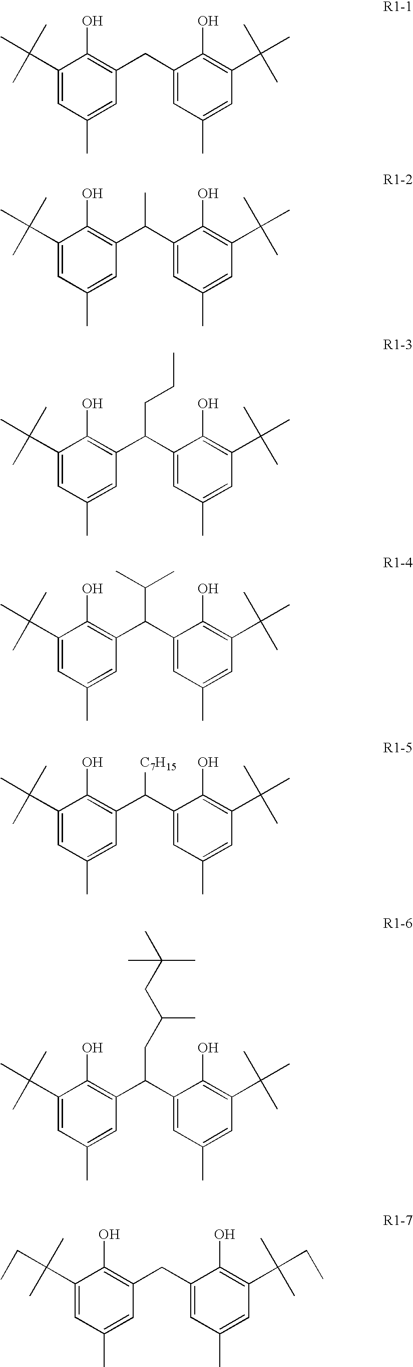

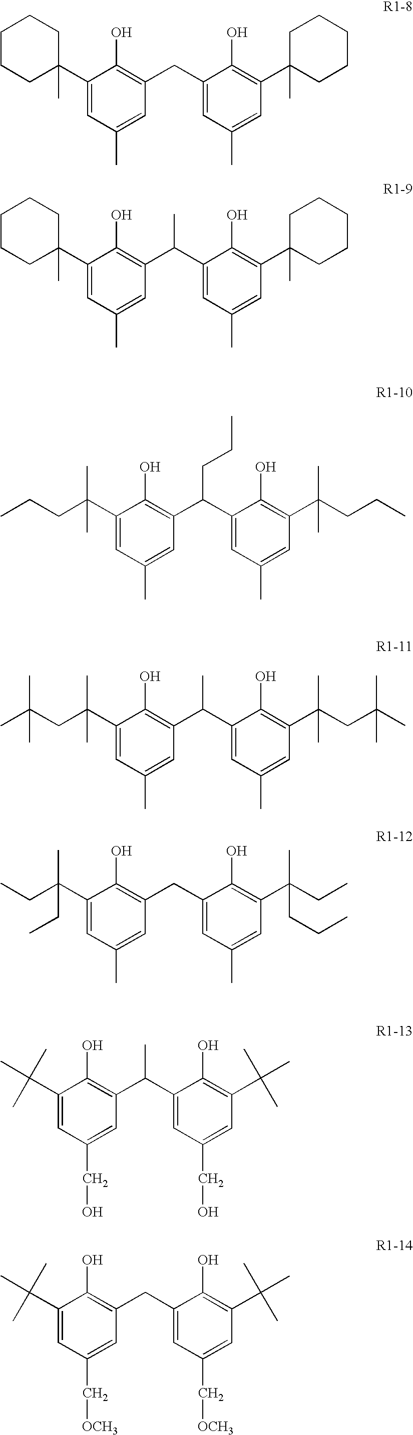

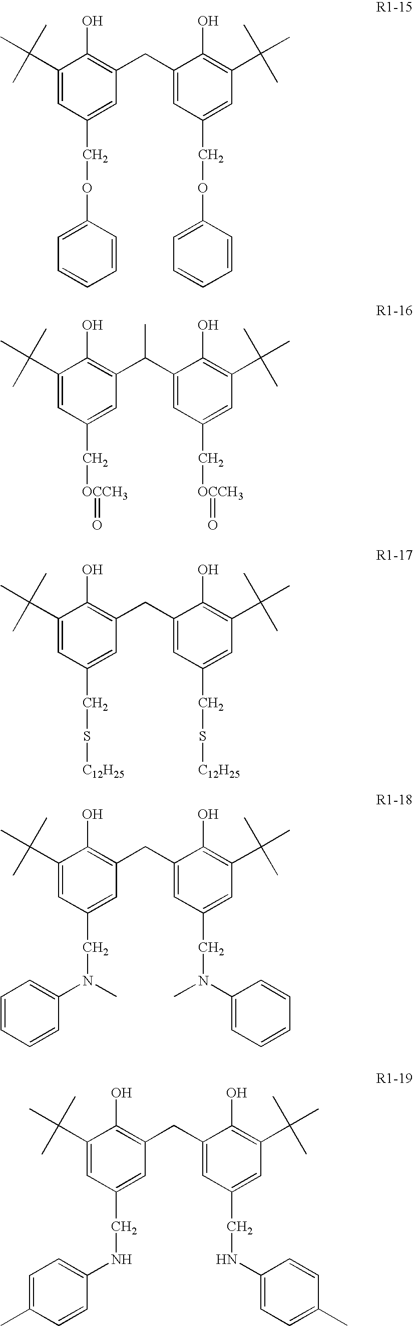

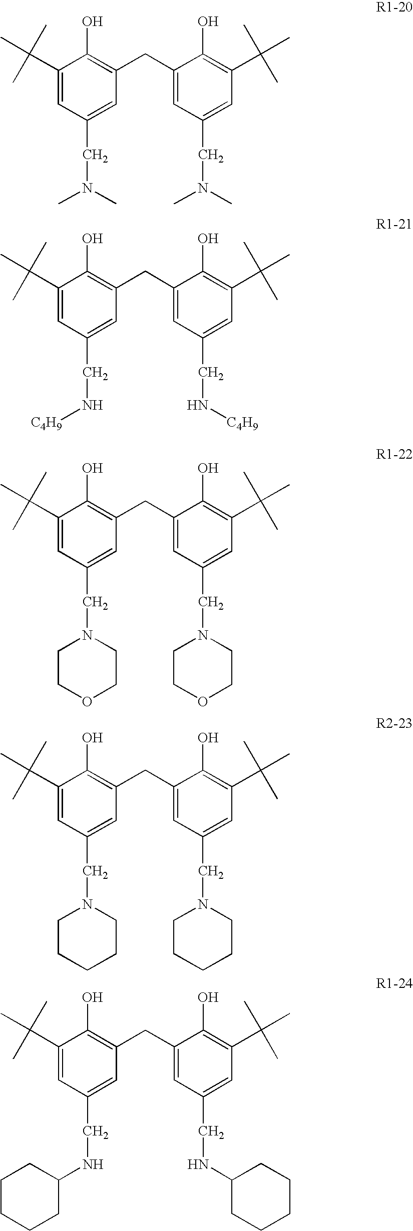

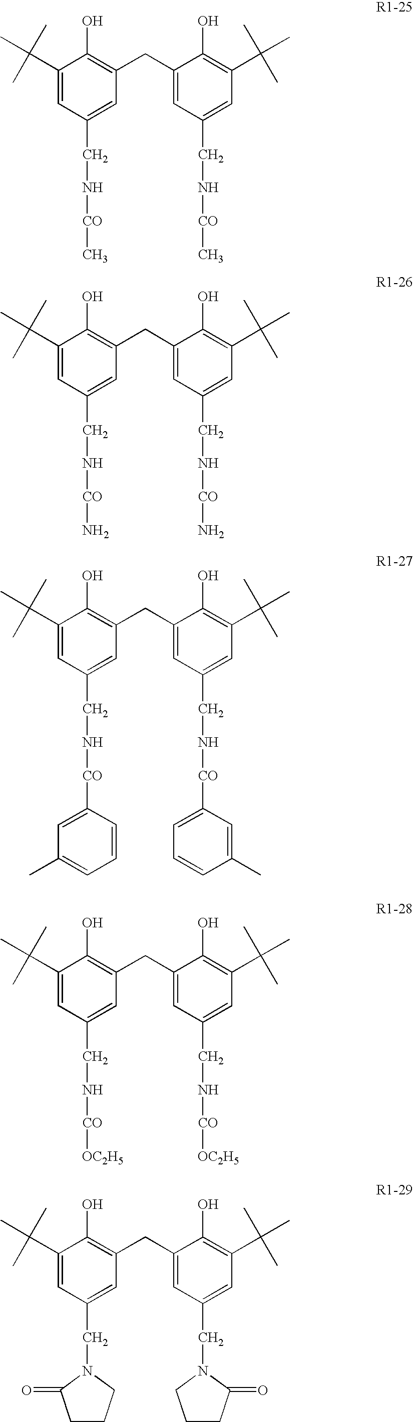

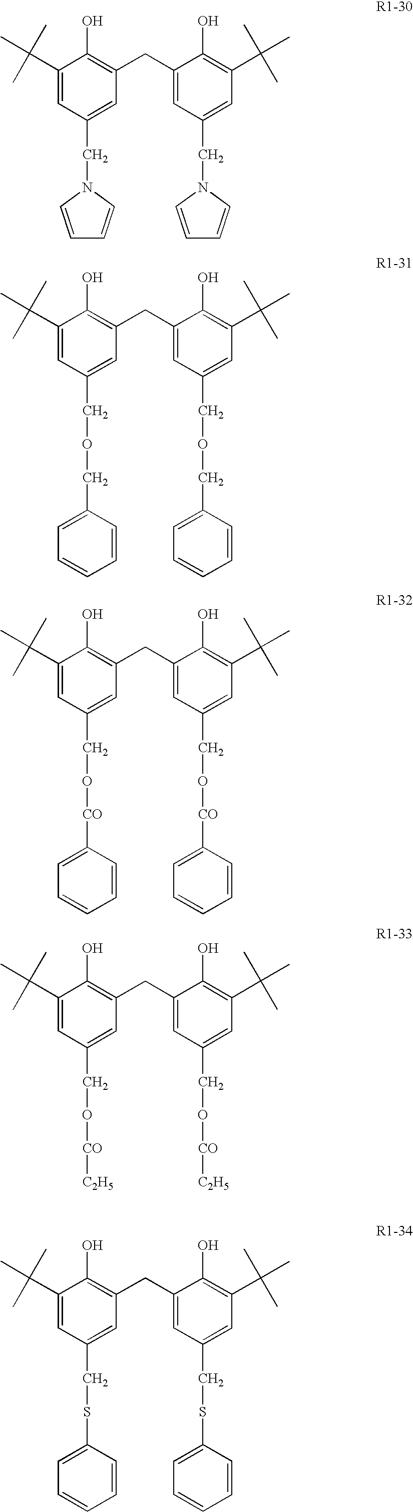

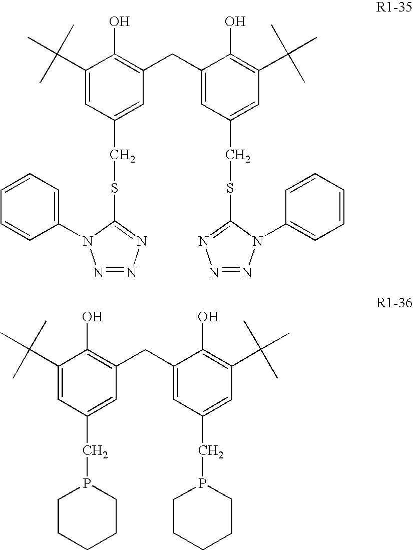

In addition, preferable reducing agents are also disclosed in JP-A Nos. 2001-188314, 2001-209145, 2001-350235, and 2002-156727, and EP 1278101A2, the disclosures of which are incorporated herein by reference.

The amount of the reducing agent in the photothermographic material is preferably 0.1 to 3.0 g/m², more preferably 0.2 to 2.0 g/m², furthermore preferably 0.3 to 1.0 g/m². Further, the mole ratio of the reducing agent to silver on the image-forming layer side is preferably 5 to 50 mol %, more preferably 8 to 30 mol %, further preferably 10 to 20 mol %.

The reducing agent may be added to any layer of the side having the image-forming layer. It is preferable that the reducing agent is included in the image-forming layer.

The state of the reducing agent in the coating liquid may be any state such as a solution, an emulsion, a solid particle dispersion.

The emulsion of the reducing agent may be prepared by a well-known emulsifying method. The exemplary method comprises: dissolving the reducing agent in an oil such as dibutyl phthalate, tricresyl phosphate, dioctyl sebacate, or tri(2-ethylhexyl)phosphate, optionally using a cosolvent such as ethyl acetate or cyclohexanone; and then mechanically emulsifying the reducing agent in the presence of a surfactant such as sodium dodecylbenzene sulfonate, sodium oleoyl-N-methyltaurinate, or sodium di(2-ethylhexyl)sulfosuccinate. In this method, it is preferable to add a polymer such as α-methylstyrene oligomer or poly(t-butylacrylamide) to the emulsion in order to control the viscosity and the refractive index of the oil droplets.

In an embodiment, the solid particle dispersion is prepared by a method comprising dispersing powder of the reducing agent in an appropriate solvent such as water using a ball mill, a colloid mill, a vibration ball mill, a sand mill, a jet mill, a roll mill, or ultrasonic wave. A protective colloid (e.g. a polyvinyl alcohol) and/or a surfactant such as an anionic surfactant (e.g. a mixture of sodium triisopropylnaphthalenesulfonates each having a different combination of the substitution positions of the three isopropyl groups) may be used in the preparation. Beads of zirconia, etc. are commonly used as a dispersing medium in the above mills, and in some cases Zr, etc. is eluted from the beads and mixed with the dispersion. The amount of the eluted and mixed component depends on the dispersion conditions, and is generally within the range of 1 to 1,000 ppm. The eluted zirconia does not cause practical problems as long as the amount of Zr in the photothermographic material is 0.5 mg or smaller per 1 g of silver.

In a preferable embodiment, the aqueous dispersion includes an antiseptic agent such as a benzoisothiazolinone sodium salt.

The reducing agent is particularly preferably used in the state of a solid particle dispersion. The reducing agent is preferably added in the form of fine particles having an average particle size of 0.01 to 10 μm, more preferably 0.05 to 5 μm, further preferably 0.1 to 2 μm. In the invention, the particle sizes of particles in other solid dispersions are preferably in the above range.

(Development Accelerator)

The photothermographic material of the invention preferably includes a development accelerator, and preferred examples thereof include sulfonamidephenol compounds represented by the formula (A) described in JP-A Nos. 2000-267222 and 2000-330234; hindered phenol compounds represented by the formula (II) described in JP-A No. 2001-92075; hydrazine compounds represented by the formula (I) described in JP-A Nos. 10-62895 and 11-15116; hydrazine compounds represented by the formula (D) described in JP-A No. 2002-156727; hydrazine compounds represented by the formula (1) described in JP-A No. 2002-278017; phenol compounds and naphthol compounds represented by the formula (2) described in JP-A No. 2001-264929; phenol compounds described in JP-A Nos. 2002-311533 and 2002-341484; and naphthol compounds described in JP-A No. 2003-66558. The disclosures of the above patent documents are incorporated herein by reference. Naphthol compounds described in JP-A No. 2003-66558 are particularly preferable. The mole ratio of the development accelerator to the reducing agent is 0.1 to 20 mol %, preferably 0.5 to 10 mol %, more preferably 1 to 5 mol %. The development accelerator may be added to the photothermographic material in any of the manners described above as examples of the method of adding the reducing agent. The development accelerator is particularly preferably added in the form of a solid dispersion or an emulsion. The emulsion of the development accelerator is preferably a dispersion prepared by emulsifying the development accelerator in a high-boiling-point solvent that is solid at ordinary temperature and a low-boiling-point cosolvent, or a so-called oilless emulsion which includes no high-boiling-point solvents.

In the invention, the hydrazine compounds described in JP-A Nos. 2002-156727 and 2002-278017, and the naphthol compounds described in JP-A No. 2003-66558 are more preferable development accelerators.

In the invention, the development accelerator is particularly preferably a compound represented by the following formula (A-1) or (A-2).
Formula (A-1); Q1-NHNH-Q2

In the formula (A-1), Q1 represents an aromatic group or a heterocyclic group each of which has a carbon atom bonded to the —NHNH-Q2 group. Q2 represents a carbamoyl group, an acyl group, an alkoxycarbonyl group, an aryloxycarbonyl group, a sulfonyl group, or a sulfamoyl group.

In the formula (A-1), the aromatic group or the heterocyclic group represented by Q1 preferably has a 5- to 7-membered unsaturated ring. Examples of the 5- to 7-membered unsaturated ring include a benzene ring, a pyridine ring, a pyrazine ring, a pyrimidine ring, a pyridazine ring, a 1,2,4-triazine ring, a 1,3,5-triazine ring, a pyrrole ring, an imidazole ring, a pyrazole ring, a 1,2,3-triazole ring, a 1,2,4-triazole ring, a tetrazole ring, a 1,3,4-thiadiazole ring, a 1,2,4-thiadiazole ring, a 1,2,5-thiadiazole ring, a 1,3,4-oxadiazole ring, a 1,2,4-oxadiazole ring, a 1,2,5-oxadiazole ring, a thiazole ring, an oxazole ring, an isothiazole ring, an isoxazole ring, a thiophene ring, and condensed rings thereof.

The ring may have a substituent. When the ring has two or more substituents, they may be the same as each other or different from each other. Examples of the substituents include halogen atoms, alkyl groups, aryl groups, carbonamide groups, alkylsulfonamide groups, arylsulfonamide groups, alkoxy groups, aryloxy groups, alkylthio groups, arylthio groups, carbamoyl groups, sulfamoyl groups, a cyano group, alkylsulfonyl groups, arylsulfonyl groups, alkoxycarbonyl groups, aryloxycarbonyl groups, and acyl groups. These substituents may further have substituents, and preferred examples thereof include halogen atoms, alkyl groups, aryl groups, carbonamide groups, alkylsulfonamide groups, arylsulfonamide groups, alkoxy groups, aryloxy groups, alkylthio groups, arylthio groups, acyl groups, alkoxycarbonyl groups, aryloxycarbonyl groups, carbamoyl groups, a cyano group, sulfamoyl groups, alkylsulfonyl groups, arylsulfonyl groups, and acyloxy groups.

When Q2 represents a carbamoyl group, the carbamoyl group preferably has 1 to 50 carbon atoms, and more preferably has 6 to 40 carbon atoms. Examples of the carbamoyl group include unsubstituted carbamoyl, methylcarbamoyl, N-ethylcarbamoyl, N-propylcarbamoyl, N-sec-butylcarbamoyl, N-octylcarbamoyl, N-cyclohexylcarbamoyl, N-tert-butylcarbamoyl, N-dodecylcarbamoyl, N-(3-dodecyloxypropyl)carbamoyl, N-octadecylcarbamoyl, N-{3-(2,4-tert-pentylphenoxy)propyl}carbamoyl, N-(2-hexyldecyl)carbamoyl, N-phenylcarbamoyl, N-(4-dodecyloxyphenyl)carbamoyl, N-(2-chloro-5-dodecyloxycarbonylphenyl)carbamoyl, N-naphtylcarbamoyl, N-3-pyridylcarbamoyl, and N-benzylcarbamoyl.

When Q2 represents an acyl group, the acyl group preferably has 1 to 50 carbon atoms, and more preferably has 6 to 40 carbon atoms. Examples of the acyl group include formyl, acetyl, 2-methylpropanoyl, cyclohexylcarbonyl, octanoyl, 2-hexyldecanoyl, dodecanoyl, chloroacetyl, trifluoroacetyl, benzoyl, 4-dodecyloxybenzoyl, and 2-hydroxymethylbenzoyl.

When Q2 represents an alkoxycarbonyl group, the alkoxycarbonyl group preferably has 2 to 50 carbon atoms, and more preferably has 6 to 40 carbon atoms. Examples of the alkoxycarbonyl group include methoxycarbonyl, ethoxycarbonyl, isobutyloxycarbonyl, cyclohexyloxycarbonyl, dodecyloxycarbonyl, and benzyloxycarbonyl.

When Q2 represents an aryloxycarbonyl group, the aryloxycarbonyl group preferably has 7 to 50 carbon atoms, and more preferably has 7 to 40 carbon atoms. Examples of the aryloxycarbonyl group include phenoxycarbonyl, 4-octyloxyphenoxycarbonyl, 2-hydroxymethylphenoxycarbonyl, and 4-dodecyloxyphenoxycarbonyl.

When Q2 represents a sulfonyl group, the sulfonyl group preferably has 1 to 50 carbon atoms, and more preferably has 6 to 40 carbon atoms. Examples of the sulfonyl groups include methylsulfonyl, butylsulfonyl, octylsulfonyl, 2-hexadecylsulfonyl, 3-dodecyloxypropylsulfonyl, 2-octyloxy-5-tert-octylphenylsulfonyl, and 4-dodecyloxyphenylsulfonyl.

When Q2 represents a sulfamoyl group, the sulfamoyl group preferably has 0 to 50 carbon atoms, and more preferably has 6 to 40 carbon atoms. Examples of the sulfamoyl group include unsubstituted sulfamoyl, N-ethylsulfamoyl, N-(2-ethylhexyl)sulfamoyl, N-decylsulfamoyl, N-hexadecylsulfamoyl, N-{3-(2-ethylhexyloxy)propyl}sulfamoyl, N-(2-chloro-5-dodecyloxycarbonylphenyl)sulfamoyl, and N-(2-tetradecyloxyphenyl)sulfamoyl.

The group represented by Q2 may have a substituent selected from the groups described above as examples of the substituent on the 5- to 7-membered unsaturated ring of Q1. When the group represented by Q2 has two or more substituents, the substituents may be the same as each other or different from each other.

The group represented by Q1 preferably has a 5- or 6-membered unsaturated ring, and more preferably has a benzene ring, a pyrimidine ring, a 1,2,3-triazole ring, a 1,2,4-triazole ring, a tetrazole ring, a 1,3,4-thiadiazole ring, a 1,2,4-thiadiazole ring, a 1,3,4-oxadiazole ring, a 1,2,4-oxadiazole ring, a thiazole ring, an oxazole ring, an isothiazole ring, an isoxazole ring, or a condensed ring in which any of the above rings is fused with a benzene ring or an unsaturated heterocycle. Q2 represents preferably a carbamoyl group, particularly preferably a carbamoyl group having a hydrogen atom on the nitrogen atom.

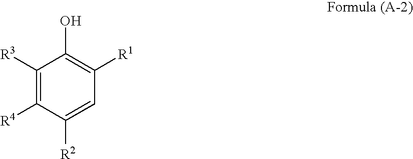

In the formula (A-2), R₁ represents an alkyl group, an acyl group, an acylamino group, a sulfonamide group, an alkoxycarbonyl group, or a carbamoyl group. R₂ represents a hydrogen atom, a halogen atom, an alkyl group, an alkoxy group, an aryloxy group, an alkylthio group, an arylthio group, an acyloxy group, or a carbonic acid ester group. R₃ and R⁴ each independently represent a substituent which can be bonded to the benzene ring, which may be selected from the substituents described above in the explanation on the formula (A-1). R₃ and R₄ may combine to form a condensed ring.

R₁ represents preferably an alkyl group having 1 to 20 carbon atoms such as a methyl group, an ethyl group, an isopropyl group, a butyl group, a tert-octyl group, or a cyclohexyl group; an acylamino group such as an acetylamino group, a benzoylamino group, a methylureido group, or a 4-cyanophenylureido group; or a carbamoyl group such as an n-butylcarbamoyl group, an N,N-diethylcarbamoyl group, a phenylcarbamoyl group, a 2-chlorophenylcarbamoyl group, or a 2,4-dichlorophenylcarbamoyl group. R₁ represents more preferably an acylamino group, which may be an ureido group or a urethane group. R₂ represents preferably a halogen atom (more preferably a chlorine atom or a bromine atom); an alkoxy group such as a methoxy group, a butoxy group, an n-hexyloxy group, an n-decyloxy group, a cyclohexyloxy group, or a benzyloxy group; or an aryloxy group such as a phenoxy group or a naphthoxy group.

R₃ represents preferably a hydrogen atom, a halogen atom, or an alkyl group having 1 to 20 carbon atoms, most preferably a halogen atom. R₄ represents preferably a hydrogen atom, an alkyl group, or an acylamino group, more preferably an alkyl group or an acylamino group. Preferred examples of the group represented by R₃ or R₄ are equal to the above-described examples of the group represented by R₁. When R₄ represents an acylamino group, R₄ and R₃ may be bound to each other to form a carbostyryl ring.

When R₃ and R₄ combine with each other to form a condensed ring in the formula (A-2), the condensed ring is particularly preferably a naphthalene ring. The naphthalene ring may have a substituent selected from the above-described examples of the substituents on the ring of Q1 in the formula (A-1). When the compound represented by the formula (A-2) is a naphthol-based compound, R₁ represents preferably a carbamoyl group, particularly preferably a benzoyl group. R₂ represents preferably an alkoxy group or an aryloxy group, particularly preferably an alkoxy group.

Preferable examples of the development accelerator are illustrated below without intention of restricting the scope of the present invention. 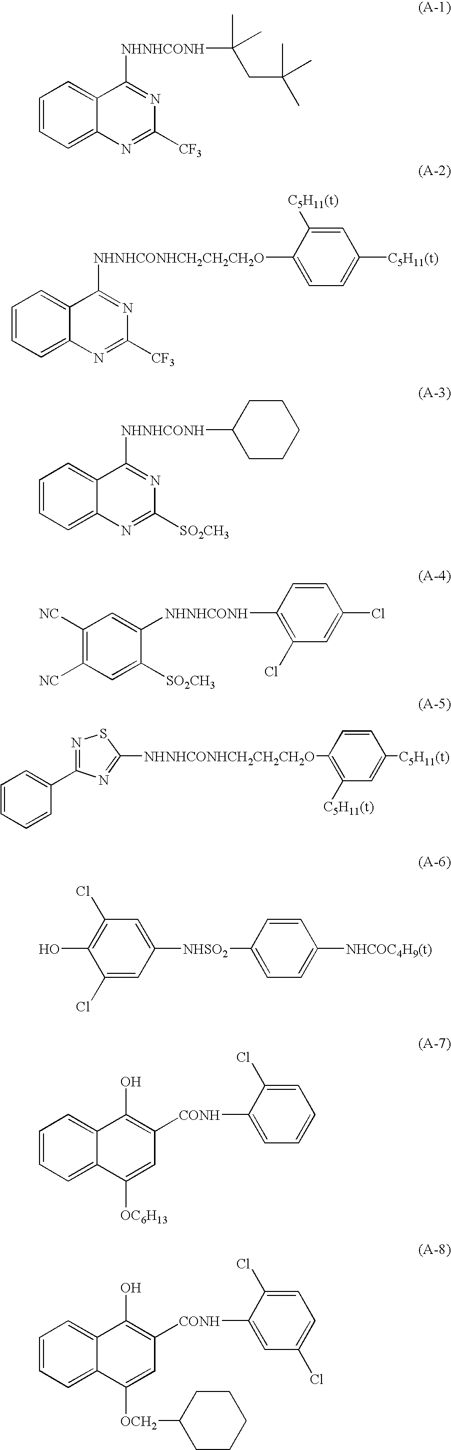 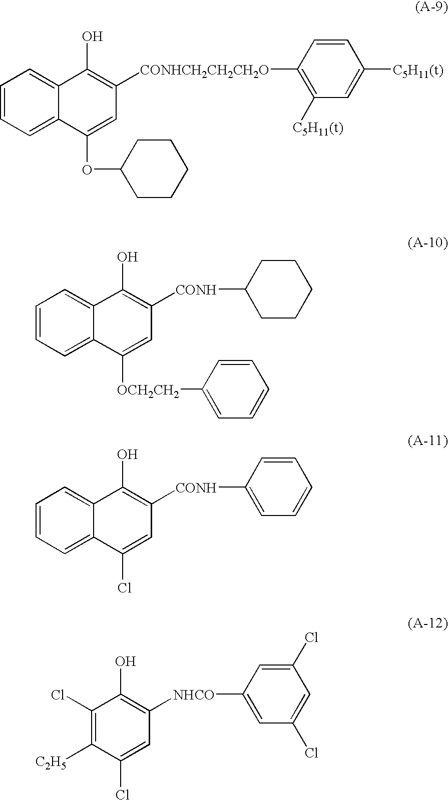
(Hydrogen-Bonding Compound)

When the reducing agent has an aromatic hydroxyl group (—OH) or amino group (—NHR, in which R represents a hydrogen atom or an alkyl group), particularly when the reducing agent is the above-mentioned bisphenol compound, it is preferable to use a non-reducing, hydrogen-bonding compound having a group capable of forming a hydrogen bond with the hydroxyl or amino group.

Examples of the group capable of forming a hydrogen bond with the hydroxyl or amino group include phosphoryl groups, sulfoxide groups, sulfonyl groups, carbonyl groups, amide groups, ester groups, urethane groups, ureido groups, tertiary amino groups, and nitrogen-including aromatic groups. The group capable of forming a hydrogen bond with the hydroxyl or amino group is preferably a phosphoryl group; a sulfoxide group; an amide group having no >N—H groups, but the nitrogen atom being blocked as >N—Ra (in which Ra represents a substituent); an urethane group having no >N—H groups, the nitrogen atom being blocked as >N—Ra (in which Ra represents a substituent); and an ureido group having no >N—H group, but the nitrogen atom being blocked as >N—Ra (in which Ra represents a substituent).

The hydrogen-bonding compound used in the invention is particularly preferably a compound represented by the following formula (D):

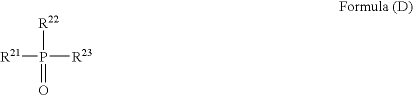

In the formula (D), R²¹ to R²³ each independently represent an alkyl group, an aryl group, an alkoxy group, an aryloxy group, an amino group, or a heterocyclic group. These groups each may be unsubstituted or substituted.

When any of R²¹ to R²³ has a substituent, examples of the substituent include halogen atoms, alkyl groups, aryl groups, alkoxy groups, amino groups, acyl groups, acylamino groups, alkylthio groups, arylthio groups, sulfonamide groups, acyloxy groups, oxycarbonyl groups, carbamoyl groups, sulfamoyl groups, sulfonyl groups, and phosphoryl groups. Preferred substituents are alkyl groups and aryl groups, and specific examples thereof include a methyl group, an ethyl group, an isopropyl group, a t-butyl group, a t-octyl group, a phenyl group, 4-alkoxyphenyl groups, and 4-acyloxyphenyl groups.

When any of R²¹ to R²³ represents an alkyl group, examples thereof include a methyl group, an ethyl group, a butyl group, an octyl group, a dodecyl group, an isopropyl group, a t-butyl group, a t-amyl group, a t-octyl group, a cyclohexyl group, a 1-methylcyclohexyl group, a benzyl group, a phenethyl group, and a 2-phenoxypropyl group.

When any of R²¹ to R²³ represents an aryl group, examples thereof include a phenyl group, a cresyl group, a xylyl group, a naphtyl group, a 4-t-butylphenyl group, a 4-t-octylphenyl group, a 4-anisidyl group, and a 3,5-dichlorophenyl group.

When any of R²¹ to R²³ represents an alkoxy group, examples thereof include a methoxy group, an ethoxy group, a butoxy group, an octyloxy group, a 2-ethylhexyloxy group, a 3,5,5-trimethylhexyloxy group, a dodecyloxy group, a cyclohexyloxy group, a 4-methylcyclohexyloxy group, and a benzyloxy group.

When any of R²¹ to R²³ represents an aryloxy group, examples thereof include a phenoxy group, a cresyloxy group, an isopropylphenoxy group, a 4-t-butylphenoxy group, a naphthoxy group, and a biphenyloxy group.

When any of R²¹ to R²³ represents an amino group, examples thereof include a dimethylamino group, a diethylamino group, a dibutylamino group, a dioctylamino group, an N-methyl-N-hexylamino group, a dicyclohexylamino group, a diphenylamino group, and an N-methyl-N-phenylamino group.

R²¹ to R²³ are each preferably an alkyl group, an aryl group, an alkoxy group, or an aryloxy group. In order to obtain the effects of the invention, in a preferable embodiment, at least one of R²¹ to R²³ represents an alkyl group or an aryl group. In a more preferable embodiment, two or more of R²¹ to R²³ represent groups selected from alkyl groups and aryl groups. Further, it is preferable to use a compound represented by the formula (D) in which R²¹ to R²³ represent the same groups, from the viewpoint of reducing the cost.

Specific examples of the hydrogen-bonding compound (such as a compound represented by the formula (D)) are illustrated below without intention of restricting the scope of the present invention.

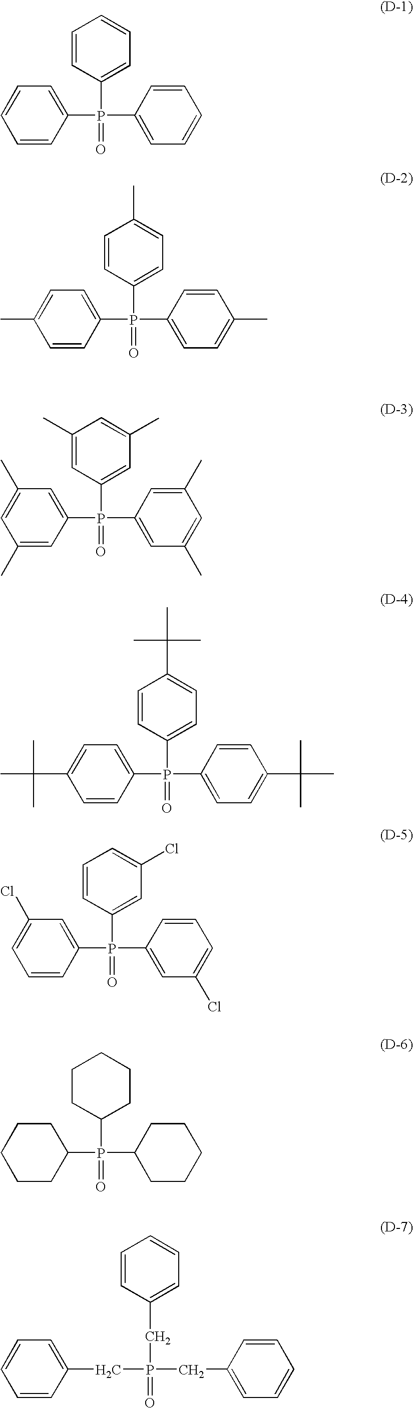

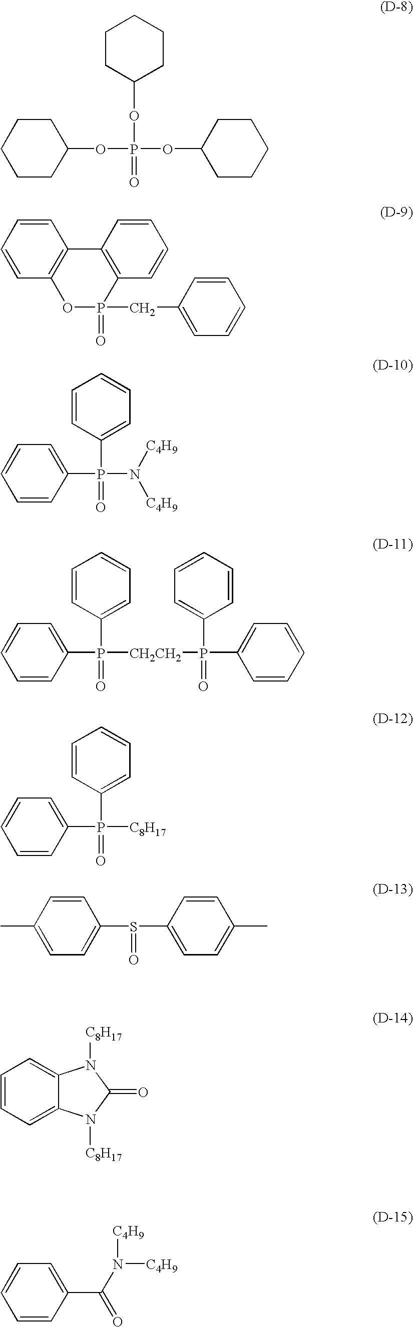

Specific examples of the hydrogen-bonding compound further include compounds disclosed in EP No. 1096310, and JP-A Nos. 2002-156727 and 2002-318431, the disclosures of which are incorporated by reference herein.

The compound of the formula (D) may be added to the coating liquid and used in the photothermographic material in the form of a solution, an emulsion, or a solid particle dispersion. The specific manner of producing the solution, emulsion, or solid particle dispersion may be the same as in the case of the reducing agent. The compound is preferably used in the form of a solid dispersion. The hydrogen-bonding compound forms a hydrogen-bond complex with the reducing agent having a phenolic hydroxyl group or an amino group in the solution. The complex can be isolated as a crystal depending on the combination of the reducing agent and the compound of the formula (D).

It is particularly preferable to use the powder of the isolated crystal to form a solid particle dispersion, from the viewpoint of achieving stable performances. In a preferable embodiment, powder of the reducing agent and powder of the compound of the formula (D) are mixed, and then the mixture is dispersed in the presence of a dispersing agent by a sand grinder mill, etc., thereby forming the complex in the dispersing process.

The mole ratio of the compound represented by the formula (D) to the reducing agent is preferably 1 to 200 mol %, more preferably 10 to 150 mol %, further preferably 20 to 100 mol %.

(Silver Halide)

1) Halogen Composition

The halogen composition of the photosensitive silver halide used in the invention is not particularly restricted, and may be silver chloride, silver chlorobromide, silver bromide, silver iodobromide, silver iodochlorobromide, or silver iodide. Among them, silver bromide, silver iodobromide, and silver iodide are preferable. In a grain of the photosensitive silver halide, the halogen composition may be uniform in the entire grain, or may vary stepwise or steplessly. In an embodiment, the photosensitive silver halide grain has a core-shell structure. The core-shell structure is preferably a 2- to 5-layered structure, more preferably a 2- to 4-layered structure. It is also preferable to employ techniques for localizing silver bromide or silver iodide on the surface of the grain of silver chloride, silver bromide, or silver chlorobromide.

2) Method of Forming a Photosensitive Silver Halide Grain

Methods of forming the photosensitive silver halide grain are well known in the field. For example, the methods described in Research Disclosure, No. 17029, June 1978 (the disclosure of which is incorporated by reference) and U.S. Pat. No. 3,700,458 (the disclosure of which is incorporated by reference) may be used in the invention. In an embodiment, the photosensitive silver halide grains are prepared by: adding a silver source and a halogen source to a solution of gelatin or another polymer to form a photosensitive silver halide; and then mixing the silver halide with an organic silver salt. The methods disclosed in the following documents are also preferable: JP-A No. 11-119374, Paragraph 0217 to 0224, and JP-A Nos. 11-352627 and 2000-347335, the disclosure of which are incorporated by reference herein.

3) Grain Size

The grain size of the photosensitive silver halide grain is preferably small so as to suppress the clouding after image formation. Specifically, the grain size is preferably 0.20 μm or smaller, more preferably 0.01 μm to 0.15 μm, further preferably 0.02 μm to 0.12 μm. The grain size of the photosensitive silver halide grain is the average diameter of the circle having the same area as the projected area of the grain; in the case of tabular grain, the projected area refers to the projected area of the principal plane.

4) Shape of Photosensitive Silver Halide Grain

The photosensitive silver halide grain may be a cuboidal grain, an octahedral grain, a tabular grain, a spherical grain, a rod-shaped grain, a potato-like grain, etc. In the invention, the cuboidal grain is preferable. Silver halide grains with roundish corners are also preferable. The face index (Miller index) of the outer surface plane of the photosensitive silver halide grain is not particularly limited. In a preferable embodiment, the silver halide grains have a high proportion of {100} faces; a spectrally sensitizing dye adsorbed to the {100} faces exhibits a higher spectral sensitization efficiency. The proportion of the {100} faces is preferably 50% or higher, more preferably 65% or higher, further preferably 80% or higher. The proportion of the {100} faces according to the Miller indices can be determined by a method described in T. Tani, J. Imaging Sci., 29, 165 (1985) (the disclosure of which is incorporated herein by reference) using adsorption dependency between {111} faces and {100} faces upon adsorption of a sensitizing dye.

5) Heavy Metal

The photosensitive silver halide grain used in the invention may include a metal selected from the metals of Groups 6 to 13 of the Periodic Table of Elements (having Groups 1 to 18) or a complex thereof, preferably a metal selected from the metals of Groups 6 to 10 of the Periodic Table of Elements or a complex thereof. When the photosensitive silver halide grain includes a metal selected from the metals of Groups 6 to 13 of the Periodic Table of Elements or a metal complex containing a metal selected from the metals of Groups 6 to 13 as the central metal, the metal or the central metal is preferably rhodium, ruthenium, iridium or iron. The metal complex may be used singly or in combination with another complex including the same or different metal. The amount of the metal or the metal complex is preferably 1×10⁻⁹ mol to 1×10⁻³ mol per 1 mol of silver. The heavy metals, the metal complexes, and methods of adding them are described, for example, in JP-A No. 7-225449, JP-A No. 11-65021, Paragraph 0018 to 0024, and JP-A No. 11-119374, Paragraph 0227 to 0240, the disclosures of which are incorporated by reference herein.

In the invention, the silver halide grain is preferably a silver halide grain having a hexacyano metal complex on its outer surface. Examples of the hexacyano metal complex include [Fe(CN)₆]⁴⁻, [Fe(CN)₆]³⁻, [Ru(CN)₆]⁴⁻, [Os(CN)₆]⁴⁻, [Co(CN)₆]³⁻, [Rh(CN)₆]³⁻, [Ir(CN)₆]³⁻, [Cr(CN)₆]³⁻, and [Re(CN)₆]³⁻. The hexacyano metal complex is preferably a hexacyano Fe complex.

The counter cation of the hexacyano metal complex is not important because the hexacyano metal complex exists as an ion in an aqueous solution. The counter cation is preferably a cation which is highly miscible with water and suitable for precipitating the silver halide emulsion; examples thereof include alkaline metal ions such as a sodium ion, a potassium ion, a rubidium ion, a cesium ion, and a lithium ion; and ammonium and alkylammonium ions such as a tetramethylammonium ion, a tetraethylammonium ion, a tetrapropylammonium ion, and a tetra-(n-butyl)-ammonium ion.

The hexacyano metal complex may be added in the form of a solution in water, or in a mixed solvent of water and a water-miscible organic solvent (e.g. an alcohol, an ether, a glycol, a ketone, an ester, an amide, etc.), or in a gelatin.

The amount of the hexacyano metal complex to be added is preferably 1×10⁻⁵ mol to ×10⁻² mol per 1 mol of silver, more preferably 1×10⁻⁴ mol to 1×10⁻³ mol per 1 mol of silver.

In order to allow the hexacyano metal complex to exist on the outer surface of the silver halide grains, the hexacyano metal complex may be directly added to the silver halide grains after the completion of the addition of an aqueous silver nitrate solution for grain formation but before the chemical sensitization (which may be chalcogen sensitization such as sulfur sensitization, selenium sensitization, or tellurium sensitization or may be noble metal sensitization such as gold sensitization). Specifically, the hexacyano metal complex may be directly added to the silver halide grains before the completion of the preparation step, in the water-washing step, in the dispersion step, or before the chemical sensitization step. It is preferable to add the hexacyano metal complex immediately after grain formation but before the completion of the preparation step so as to prevent excess growth of the silver halide grains.

In an embodiment, the addition of the hexacyano metal complex is started after 96% by mass of the total amount of silver nitrate for the grain formation is added. In a preferable embodiment, the addition is started after 98% by mass of the total amount of silver nitrate is added. In a more preferable embodiment, the addition is started after 99% by mass of the total amount of silver nitrate is added.

When the hexacyano metal complex is added after the addition of the aqueous silver nitrate solution but immediately before the completion of the grain formation, the hexacyano metal complex is adsorbed onto the outer surface of the silver halide grain, and most of the adsorbed hexacyano metal complex forms a hardly-soluble salt with silver ion on the surface. The silver salt of hexacyano iron (II) is less soluble than AgI and thus preventing redissolution of the fine grains, whereby the silver halide grains with a smaller grain size can be produced.

The metal atoms and metal complexes such as [Fe(CN)₆]⁴⁻ which may be added to the silver halide grains, and the desalination methods and the chemical sensitization methods for the silver halide emulsion are described in JP-A No. 11-84574, Paragraph 0046 to 0050, JP-A No. 11-65021, Paragraph 0025 to 0031, and JP-A No. 11-119374, Paragraph 0242 to 0250, the disclosures of which are incorporated herein by reference.

6) Gelatin

In the invention, the gelatin contained in the photosensitive silver halide emulsion may be selected from various gelatins. The gelatin has a molecular weight of preferably 10,000 to 1,000,000 so as to maintain the excellent dispersion state of the photosensitive silver halide emulsion in the coating liquid including the organic silver salt. Substituents on the gelatin are preferably phthalated. The gelatin may be added during the grain formation or during the dispersing process after the desalting treatment, and is preferably added during the grain formation.

7) Sensitizing Dye

The sensitizing dye used in the invention is a sensitizing dye which can spectrally sensitize the silver halide grains when adsorbed by the grains, so that the sensitivity of the silver halide is heightened in the desired wavelength range. The sensitizing dye may be selected from sensitizing dyes having spectral sensitivities which are suitable for spectral characteristics of the exposure light source. The sensitizing dyes and methods of adding them are described, for example, in JP-A No. 11-65021, Paragraph 0103 to 0109; JP-A No. 10-186572 (the compounds represented by the formula (II)); JP-A No. 11-119374 (the dyes represented by the formula (I) and Paragraph 0106); U.S. Pat. No. 5,510,236; U.S. Pat. No. 3,871,887 (the dyes described in Example 5); JP-A No. 2-96131; JP-A No. 59-48753 (the dyes disclosed therein); EP-A No. 0803764A1, Page 19, Line 38 to Page 20, Line 35; JP-A Nos. 2001-272747, 2001-290238, and 2002-23306, the disclosures of which are incorporated herein by reference. Only a single sensitizing dye may be used or two or more sensitizing dyes may be used. In an embodiment, the sensitizing dye is added to the silver halide emulsion after the desalination but before the coating. In a preferable embodiment, the sensitizing dye is added to the silver halide emulsion after the desalination but before the completion of the chemical ripening.

The amount of the sensitizing dye to be added may be selected in accordance with the sensitivity and the fogging properties, and is preferably 10⁻⁶ mol to 1 mol per 1 mol of the silver halide in the image-forming layer, more preferably 10⁻⁴ mol to 10⁻¹ mol per 1 mol of the silver halide in the image-forming layer.

In the invention, a super-sensitizer may be used in order to increase the spectral sensitization efficiency. Examples of the super-sensitizer include compounds described in EP-A No. 587,338, U.S. Pat. Nos. 3,877,943 and 4,873,184, JP-A Nos. 5-341432, 11-109547, and 10-111543, the disclosures of which are incorporated herein by reference.

8) Chemical Sensitization

It is preferred that the photosensitive silver halide grains are chemically sensitized by methods selected from the sulfur sensitization method, the selenium sensitization method, or the tellurium sensitization method. Known compounds such as the compounds described in JP-A No. 7-128768 (the disclosure of which is incorporated herein by reference) may be used in the sulfur sensitization method, the selenium sensitization method, and the tellurium sensitization method. In the invention, the tellurium sensitization is preferred, and it is preferable to use a compound or compounds selected from the compounds described in JP-A No. 11-65021, Paragraph 0030 and compounds represented by the formula (II), (III), or (IV) described in JP-A No. 5-313284, the disclosures of which are incorporated by reference herein.

In a preferable embodiment, the photosensitive silver halide grains are chemically sensitized by the gold sensitization method, which may be conducted alone or in combination with the chalcogen sensitization. The gold sensitization method preferably uses a gold sensitizer having a gold atom with the valence of +1 or +3. The gold sensitizer is preferably a common gold compound.

Typical examples of the gold sensitizer include chloroauric acid, bromoauric acid, potassium chloroaurate, potassium bromoaurate, auric trichloride, potassium auricthiocyanate, potassium iodoaurate, tetracyanoauric acid, ammonium aurothiocyanate, and pyridyltrichloro gold. Further, the gold sensitizers described in U.S. Pat. No. 5,858,637 and JP-A No. 2002-278016 (the disclosures of which are incorporated herein by reference) are also preferable in the invention.

In the invention, the chemical sensitization may be carried out at any time between grain formation and coating. For example, the chemical sensitization may be carried out after desalination, and/but (1) before spectral sensitization, (2) during spectral sensitization, (3) after spectral sensitization, (4) immediately before coating.

The amount of the sulfur, selenium, or tellurium sensitizer may be changed in accordance with the kind of the silver halide grains, the chemical ripening condition, and the like, and is generally 10⁻⁸ mol to 10⁻² mol per 1 mol of the silver halide, preferably 10⁻⁷ mol to 10⁻³ mol per 1 mol of the silver halide.

The amount of the gold sensitizer to be added may be selected in accordance with the conditions, and is preferably 10⁻⁷ mol to 10⁻³ mol per 1 mol of the silver halide, more preferably 10⁻⁶ mol to 5×10⁻⁴ mol per 1 mol of the silver halide.

The conditions for the chemical sensitization are not particularly restricted and are generally conditions in which pH is 5 to 8, pAg is 6 to 11, and temperature is 40 to 95° C.

A thiosulfonic acid compound may be added to the silver halide emulsion by a method described in EP-A No. 293,917, the disclosure of which is incorporated by reference herein.

In the invention, the photosensitive silver halide grains may be subjected to reduction sensitization using a reduction sensitizer. The reduction sensitizer is preferably selected from ascorbic acid, aminoiminomethanesulfinic acid, stannous chloride, hydrazine derivatives, borane compounds, silane compounds, and polyamine compounds. The reduction sensitizer may be added at any time between crystal growth and coating in the preparation of the photosensitive emulsion. It is also preferable to ripen the emulsion while maintaining the pH value of the emulsion at 7 or higher and/or maintaining the pAg value at 8.3 or lower, so as to reduction sensitize the photosensitive emulsion. Further, it is also preferable to conduct reduction sensitization by introducing a single addition part of a silver ion during grain formation.

9) Combination of Silver Halides

In an embodiment, only one kind of photosensitive silver halide emulsion is used in the photothermographic material of the invention. In another embodiment, two or more kinds of photosensitive silver halide emulsions are used in the photothermographic material; the photosensitive silver halide emulsions may be different from each other in characteristics such as average grain size, halogen composition, crystal habit, and chemical sensitization condition. The image gradation can be adjusted by using two or more kinds of photosensitive silver halide emulsions having different sensitivities. The related techniques are described, for example in JP-A Nos. 57-119341, 53-106125, 47-3929, 48-55730, 46-5187, 50-73627, and 57-150841, the disclosure of which are incorporated herein by reference. The difference in sensitivity between the emulsions is preferably 0.2 logE or larger.

10) Application Amount

The amount of the photosensitive silver halide to be applied is, in terms of the applied silver amount per 1 m² of photothermographic material, preferably 0.03 to 0.6 g/m², more preferably 0.05 to 0.4 g/m², still more preferably 0.07 to 0.3 g/m². Further, the amount of the photosensitive silver halide per 1 mol of the organic silver salt is preferably 0.01 to 0.5 mol, more preferably 0.02 to 0.3 mol, further preferably 0.03 to 0.2 mol.

11) Mixing of Photosensitive Silver Halide and Organic Silver Salt

The methods and conditions of mixing the photosensitive silver halide and the organic silver salt, which are separately prepared, are not particularly restricted as long as the advantageous effects of the invention can be sufficiently obtained. In an embodiment, the silver halide and the organic silver salt are separately prepared and then mixed by a high-speed stirrer, a ball mill, a sand mill, a colloid mill, a vibrating mill, a homogenizer, etc. In another embodiment, the prepared photosensitive silver halide is added to the organic silver salt during the preparation of the organic silver salt, and the preparation of the organic silver salt is then completed. It is preferable to mix two or more aqueous organic silver salt dispersion liquids and two or more aqueous photosensitive silver salt dispersion liquids so as to adjust the photographic properties.

12) Addition of Silver Halide to Coating Liquid

The silver halide is added to the coating liquid for the image-forming layer preferably between 180 minutes before coating and immediately before coating, more preferably between 60 minutes before coating and 10 seconds before coating. There are no particular restrictions on the methods and conditions of the coating as long as the advantageous effects of the invention can be sufficiently obtained. In an embodiment, the silver halide is mixed with the coating liquid in a tank while controlling the addition flow rate and the feeding amount to the coater, such that the average retention time calculated from the addition flow rate and the feeding amount to the coater is the desired time. In another embodiment, the silver halide is mixed with the coating liquid by a method using a static mixer described, for example, in N. Hamby, M. F. Edwards, and A. W. Nienow, translated by Koji Takahashi, Ekitai Kongo Gijutsu, Chapter 8 (Nikkan Kogyo Shimbun, Ltd., 1989), the disclosure of which is incorporated herein by reference.

(Binder)

The binder of the image-forming layer may be any polymers as far as it is hydrophilic. The binder is preferably transparent or translucent, and generally colorless. The binder may be a natural resin, polymer or copolymer, a synthetic resin, polymer or copolymer, or another film-forming medium, and specific examples thereof include gelatins, gums, polyvinyl alcohols, hydroxyethylcelluloses, cellulose acetates, polyvinylpyrrolidones, caseins, starches, polyacrylic acids and polymethylmethacrylic acids.

In the invention, it is preferred that 50% by mass to 100% by mass of a binder which may be used together with a layer containing an organic silver salt are a hydrophilic binder, and particularly preferable is that 70% by mass to 100% by mass of the hydrophilic binder are a hydrophilic binder.

An example of the hydrophilic binder includes gelatin, gelatin derivatives (alkali- or acid-treated gelatins, acetylated gelatins, oxidized gelatins, phthalated gelatins, and deionized gelatin), polysilicic acid, acrylamide/methacrylamide polymers, acryl/methacryl polymers, polyvinylpyrrolidones, poly(vinyl acetates), poly(vinylalcohols), poly(vinyllactams), polymers of sulfoalkylacrylate and sulfoalkylmethacrylate, hydrolyzed poly(vinyl acetates), polysaccharides (e.g. dextrans, etherified starches and the like), and the other synthetic or natural vehicles being essentially hydrophilic (as defined above) (e.g. see Item 38957 in Research Disclosure, the disclosure of which is incorporated by reference herein). However, the invention is not limited to the hydrophilic binders as enumerated above. Preferable are gelatin, gelatin derivatives, and poly(vinylalcohols), and more preferable are gelatin, and the gelatin derivatives.

In the invention, it is preferred that a film of an image forming layer is formed by using a coating liquid the solvent of which contains 30% by mass or more of water to apply a coating and to dry the coating, and particularly preferable is to use a coating liquid the solvent of which contains 50% by mass or more of water.

An aqueous solvent into which the above-described polymer is soluble or dispersible described herein means water or a solvent prepared by admixing 70% by mass or less of a water miscible organic solvent with water.

An example of the water miscible organic solvent includes alcohols such as methyl alcohol, ethyl alcohol, and propyl alcohol; cellosolves such as methyl cellosolve, ethyl cellosolve, and butyl cellosolve; ethyl acetate; and dimethylformamide.

The binder to be used in combination with the hydrophilic binder is preferably dispersible in an aqueous solvent. Preferred examples of the polymers dispersible in the aqueous solvents include hydrophobic polymers such as acrylic polymers, polyesters, rubbers (e.g. SBR resins), polyurethanes, polyvinyl chlorides, polyvinyl acetates, polyvinylidene chlorides, and polyolefins. The polymer may be linear, branched, or cross-linked, and may be a homopolymer derived form one monomer or a copolymer derived form two or more monomers. The copolymer may be a random copolymer or a block copolymer. The number-average molecular weight of the polymer is preferably 5,000 to 1,000,000, more preferably 10,000 to 200,000. When the number-average molecular weight is too small, the resultant image-forming layer tends to have insufficient strength. On the other hand, when the number-average molecular weight is too large, the polymer is poor in the film-forming properties. Further, cross-linkable polymer latexes are particularly preferable.

An amount of a binder in an organic silver salt-containing layer (i.e. an image forming layer) of the invention is in a mass ratio of a total silver amount of an organic acid silver salt and silver halide/a whole binder of 1.0 to 2.5, more preferably of 1.0 to 2.2, and still further preferably of 1.0 to 2.

A crosslinking agent for crosslinkage, a surfactant for improving coating properties and the like may be added to the image forming layer of the invention.

(Preferred Solvent for Coating Liquid)

In the invention, the solvent of the coating liquid for the image-forming layer is preferably an aqueous solvent including 30% by mass or more of water. The term “solvent” used herein means a solvent or a dispersion medium. The aqueous solvent may include any water-miscible organic solvent such as methyl alcohol, ethyl alcohol, isopropyl alcohol, methyl cellosolve, ethyl cellosolve, dimethylformamide, and ethyl acetate. The water content of the solvent for the coating liquid is preferably 50% by mass or higher, more preferably 70% by mass or higher. Examples of preferred solvents include water, 90/10 mixture of water/methyl alcohol, 70/30 mixture of water/methyl alcohol, 80/15/5 mixture of water/methyl alcohol/dimethylformamide, 85/10/5 mixture of water/methyl alcohol/ethyl cellosolve, and 85/10/5 mixture of water/methyl alcohol/isopropyl alcohol, the numerals representing the mass ratios (% by mass).

(Antifoggant)

Examples of antifoggants, stabilizers, and stabilizer precursors usable in the invention include compounds disclosed in JP-A No. 10-62899, Paragraph 0070 and EP-A No. 0803764A1, Page 20, Line 57 to Page 21, Line 7; compounds described in JP-A Nos. 9-281637 and 9-329864; and compounds described in U.S. Pat. No. 6,083,681 and EP No. 1048975. The disclosures of the above patent documents are incorporated herein by reference.

1) Organic Polyhalogen Compound

Organic polyhalogen compounds, which can be preferably used as the antifoggant in the invention, are described in detail below. The antifoggant is particularly preferably an organic polyhalogen compound represented by the following formula (H):

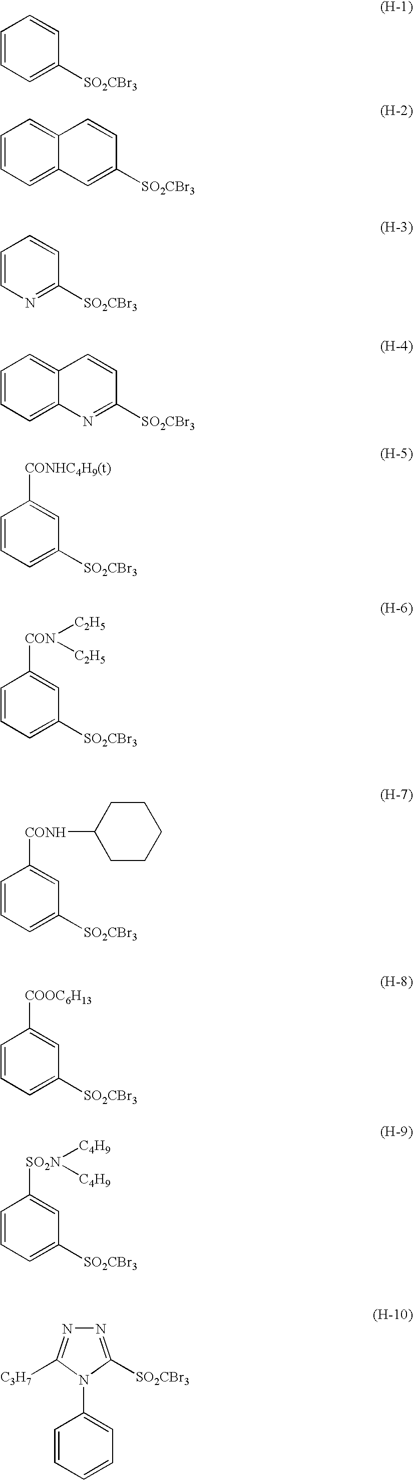

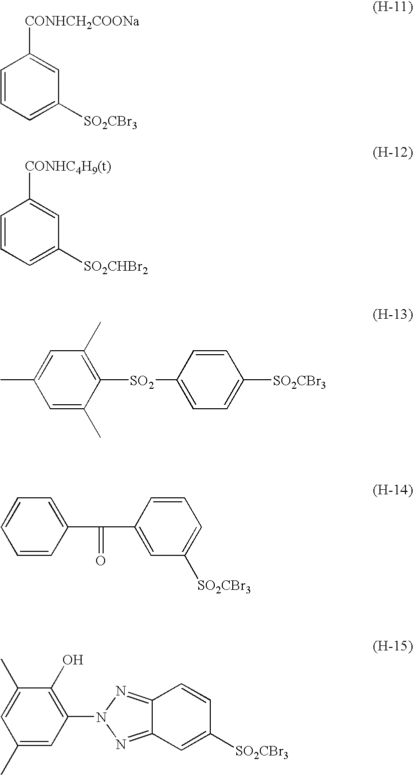

Formula (H)
Q-(Y)ₙ-C(X1 )(X2)Z.

In the formula (H), Q represents an alkyl group, an aryl group, or a heterocyclic group, Y represents a divalent linking group, n represents 0 to 1, Z represents a halogen atom, and X1 and X2 each independently represent a hydrogen atom or an electron-withdrawing group.

In the formula (H), Q represents preferably an alkyl group having 1 to 6 carbon atoms, an aryl group having 6 to 12 carbon atoms, or a heterocyclic group including at least one nitrogen atom such as a pyridyl group and a quinolyl group.

When Q represents an aryl group, the aryl group is preferably a phenyl group substituted by an electron-withdrawing group with a positive Hammett's substituent constant σp. The Hammett's substituent constant is described, for example, in Journal of Medicinal Chemistry, 1973, Vol. 16, No. 11, 1207-1216, the disclosure of which is incorporated herein by reference. Examples of such an electron-withdrawing group include halogen atoms, alkyl groups having substituents of electron-withdrawing groups, aryl groups substituted by electron-withdrawing groups, heterocyclic groups, alkyl sulfonyl groups, aryl sulfonyl groups, acyl groups, alkoxycarbonyl groups, carbamoyl groups, and sulfamoyl groups. The electron-withdrawing group is preferably a halogen atom, a carbamoyl group, or an arylsulfonyl group, particularly preferably a carbamoyl group.

At least one of X1 and X2 represents preferably an electron-withdrawing group. The electron-withdrawing group is preferably a halogen atom, an aliphatic, aryl, or heterocyclyl sulfonyl group, an aliphatic, aryl, or heterocyclyl acyl group, an aliphatic, aryl, or heterocyclyl oxycarbonyl group, a carbamoyl group, or a sulfamoyl group, more preferably a halogen atom or a carbamoyl group, particularly preferably a bromine atom.

Z represents preferably a bromine atom or an iodine atom, more preferably a bromine atom.

Y represent preferably —C(═O)—, —SO—, —SO₂—, —C(═O)N(R)—, or —SO₂N(R)—, more preferably —C(═O)—, —SO₂—, or —C(═O)N(R)—, particularly preferably —SO₂— or —C(═O)N(R)—, in which R represents a hydrogen atom, an aryl group, or an alkyl group, preferably a hydrogen atom or an alkyl group, particularly preferably a hydrogen atom.

In the formula (H), n represents 0 or 1, preferably 1.

In the formula (H), Y represents preferably —C(═O)N(R)— when Q represents an alkyl group, and Y represents preferably —SO₂— when Q represents an aryl group or a heterocyclic group.

In an embodiment, the antifoggant is a compound including two or more units represented by the formula (H), wherein each unit is bound to another unit, and a hydrogen atom in the formula (H) is substituted with the bond in each unit. Such a compound is referred to as a bis-, tris-, or tetrakis-type compound.

The compound represented by (H) is preferably substituted by a dissociative group (such as a COOH group, a salt of a COOH group, an SO₃H group, a salt of an SO₃H group, a PO₃H group, or a salt of a PO₃H group); a group containing a quaternary nitrogen cation, such as an ammonium group or a pyridinium group; a polyethyleneoxy group; a hydroxyl group; or the like.

Specific examples of the compounds represented by the formula (H) are shown below.

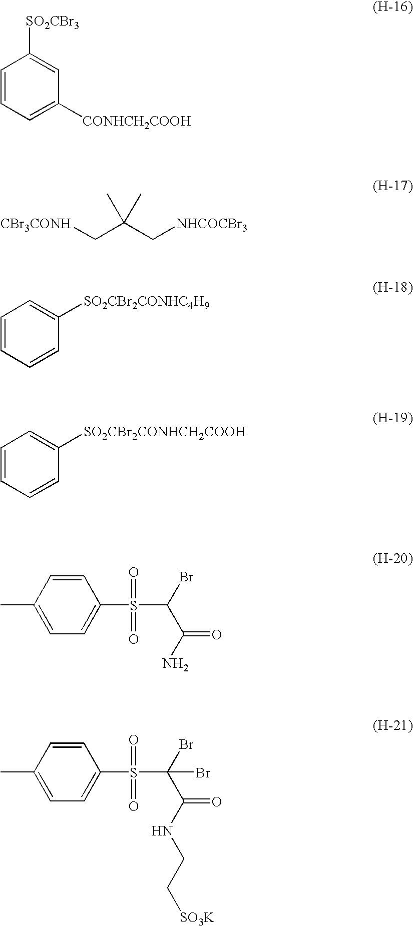

Examples of polyhalogen compounds usable in the invention include, in addition to the above compounds, compounds described in U.S. Pat. Nos. 3,874,946, 4,756,999, 5,340,712, 5,369,000, 5,464,737, and 6,506,548, and JP-A Nos. 50-137126, 50-89020, 50-119624, 59-57234, 7-2781, 7-5621, 9-160164, 9-244177, 9-244178, 9-160167, 9-319022, 9-258367, 9-265150, 9-319022, 10-197988, 10-197989, 11-242304, 2000-2963, 2000-112070, 2000-284410, 2000-284412, 2001-33911, 2001-31644, 2001-312027, and 2003-50441, the disclosure of which are incorporated herein by reference. The compounds described in JP-A Nos. 7-2781, 2001-33911, and 2001-312027 are particularly preferred.

The amount of the compound represented by formula (H) is preferably 10⁻⁴ mol to 1 mol, more preferably 10⁻³ mol to 0.5 mol, further preferably mol 10⁻² to 0.2 mol, per 1 mol of the non-photosensitive silver salt contained in the image-forming layer.

The antifoggant may be added to the photosensitive material in any of the manners described above as examples of the method of adding the reducing agent. The organic polyhalogen compound is preferably added in the state of a solid particle dispersion.

2) Other Antifoggants

Examples of other antifoggants usable in the invention include mercury (II) salts described in JP-A No. 11-65021, Paragraph 0113; benzoic acid compounds described in JP-A No. 11-65021, Paragraph 0114; salicylic acid derivatives described in JP-A No. 2000-206642; formalin scavenger compounds represented by the formula (S) described in JP-A No. 2000-221634; triazine compounds disclosed in claim 9 of JP-A No. 11-352624; compounds represented by the formula (III) described in JP-A No. 6-11791; and 4-hydroxy-6-methyl-1,3,3a,7-tetrazaindene. The disclosures of the above patent documents are incorporated herein by reference.

The photothermographic materials of the invention may further include an azolium salt for the purpose of preventing the fogging. Examples of the azolium salt include compounds represented by the formula (XI) described in JP-A No. 59-193447; compounds described in JP-B No. 55-12581; and compounds represented by the formula (II) described in JP-A No. 60-153039. The disclosures of the above patent documents are incorporated herein by reference. In an embodiment, the azolium salt is added to a layer on the same side as the image-forming layer. The layer to which the azolium salt may be added is preferably the image-forming layer. However, the azolium salt may be added to any portion of the material. The azolium salt may be added in any step in the preparation of the coating liquid. When the azolium salt is added to the image-forming layer, the azolium salt may be added in any step between the preparation of the organic silver salt and the preparation of the coating liquid. In an embodiment, the azolium salt is added during the period after the preparation of the organic silver salt but before the application of the coating liquid. The azolium salt may be added in the form of powder, a solution, a fine particle dispersion, etc. Further, the azolium salt may be added in the form of a solution which further contains other additives such as sensitizing dyes, reducing agents, and toners. The amount of the azolium salt to be added per 1 mol of silver is not particularly limited, and is preferably 1×10⁻⁶ mol to 2 mol, more preferably 1×10⁻³ mol to 0.5 mol.

(Explanation for Compounds Represented by the Formulae (I) and (II))

The compounds represented by the formulae (I) and (II) used in the invention will be described.

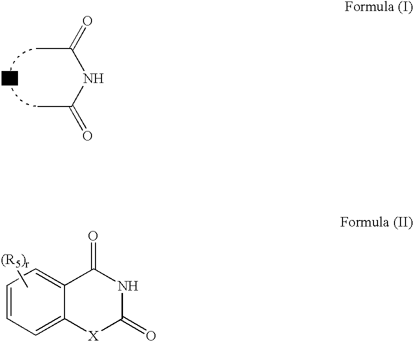

In the formula (I), Q represents an atomic group required for forming a five- to six-membered imide ring.

In the formula (II), R₅ represents independently a hydrogen atom, an alkyl group, a cycloalkyl group, an alkoxy group, an alkylthio group, an arylthio group, a hydroxy group, a halogen atom, or an N(R₈R₉) group. Two R₅ groups may bond with each other to form an aromatic, heteroaromatic, alicyclic or heterocyclic fused ring. R₈ and R₉ represent independently a hydrogen atom, an alkyl group, an aryl group, a cycloalkyl group, an alkenyl group or a heterocyclic group. R₈ and R₉ may bond with each other to form a substituted or an unsubstituted five- to seven-membered heterocyclic ring. X represents O, S, Se or N(R₆) wherein R₆ represents hydrogen or an alkyl group, an aryl group, a cycloalkyl group, an alkenyl group or a heterocyclic group. r is 0, 1, or 2.

1) Explanation of Formula (I)

To a nitrogen atom or a carbon atom contained in Q, hydrogen atom, amino group, alkyl group having 1 to 4 carbon atoms, halogen atom, keto oxygen atom, aryl group and the like may be bonded as a branch.

A specific example of a compound containing an imide ring represented by the formula (I) includes uracil, 5-bromouracil, 4-methyluracil, 5-methyluracil, 4-carboxyuracil, 4,5-dimethyluracil, 5-aminouracil, dihydrouracil, 1-ethyl-6-methyluracil, 5-carboxymethylaminouracil, barbituric acid, 5-phenylbarbituric acid, cyanuric acid, urazol, hydantoin, 5,5-dimethylhydantoin, glutarimide, glutaconimide, citrazinic acid, succinimide, 3,4-dimethylsuccinimide, maleimide, phthalimide, and naphthalimide. However, the invention is not limited to those enumerated above. Among the compounds each having an imide ring represented by the formula (I) in the invention, succinimide, phthalimide, naphthalimide, and 3,4-dimethylsuccinimide are preferable, and succinimide is particularly preferable.

2) Explanation of the Formula (II)

In the formula (II), R₅ represents independently a hydrogen atom, an alkyl group, a cycloalkyl group, an alkoxy group, an alkylthio group, an arylthio group, a hydroxy group, a halogen atom, or an N(R₈R₉) group. Two R₅ groups may bond with each other to form an aromatic, heteroaromatic, alicyclic or heterocyclic fused ring. When R₅ represents an N(R₈R₉) group, R₈ and R₉ represent independently a hydrogen atom, an alkyl group, an aryl group, a cycloalkyl group, an alkenyl group or a heterocyclic group. R₈ and R₉ may bond with each other to form a substituted or an unsubstituted five- to seven-membered heterocyclic ring. X represents O, S, Se or N(R₆) wherein R₆ represents hydrogen or an alkyl group, an aryl group, a cycloalkyl group, an alkenyl group or a heterocyclic group. r is 0, 1, or 2.

Useful alkyl groups for R₅, R₆, R₈, and R₉ are those which may be linear, branched, or cyclic ones, and which may have 1 to 20 carbon atoms, and have preferably 1 to 5 carbon atoms. An alkyl group having 1 to 4 carbon atoms (e.g. methyl, ethyl, iso-propyl, n-butyl, t-butyl, and sec-butyl) is particularly preferred.

Useful aryl groups for R₅, R₆, R₈, and R₉ are those which may have 6 to 14 carbon atoms in (one or plural) aromatic ring(s). Preferred aryl groups are phenyl groups and substituted phenyl groups.

Useful cycloalkyl groups for R₅, R₆, R₈, and R₉ are those which may have 5 to 14 carbon atoms in a central ring system. Preferred cycloalkyl groups are cyclopentyl and cyclohexyl.

Useful alkenyl groups and alkynyl groups are those which may be branched, or linear ones, and have 2 to 20 carbon atoms. A preferable alkenyl group is allyl.

Useful heterocyclic groups for R₅, R₆, R₈, and R₉ are those which may have 5 to 10 atoms including carbon, and oxygen, sulfur, and/or nitrogen atoms in a central ring system, and which may have a fused ring.

Although it is not intended to restrict the scope of the invention, these alkyl, aryl, cycloalkyl, and heterocyclic groups may be further substituted by at least one or more of group(s) of halo group, alkoxycarbonyl group, hydroxy group, alkoxy group, cyano group, acyl group, acyloxy group, carbonyloxyester group, sulfonic acid ester group, alkylthio group, dialkylamino group, carboxy group, sulfo group, phosphono group, and the other groups which may be easily found by those skilled in the art.

Useful alkoxy groups, alkylthio groups, and arylthio groups for R₅ are those which have the alkyl and aryl groups as mentioned previously. Preferred halogen atoms are chloro and bromo atoms. Typical compounds represented by the formula (II) are the following compounds II-1 to II-10. Among others, the compound II-1 is the most preferable.

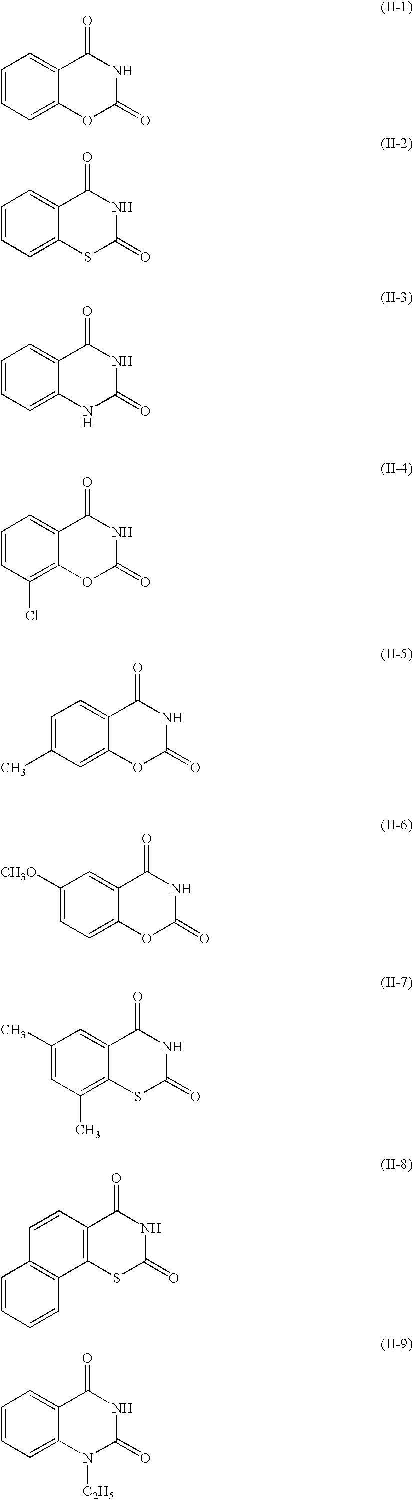

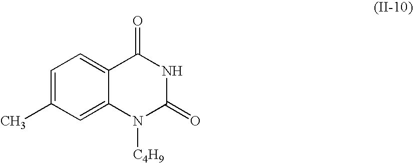

The other useful substituted benzoxazinediones are described in U.S. Pat. No. 3,951,660 (Hagemann et al.), the disclosure of which is incorporated by reference herein. The compounds represented by the formulae (I) and (II) are preferably used as toners. Examples of toners used together with the compounds represented by the formulae (I) and (II) include: phthalazinone, phthalazinone derivatives, metallic salts of these derivatives, for example, 4-(1-naphthyl)phthalazinone, 6-chlorophthalazinone, 5,7-dimethoxyphthalazinone, and 2,3-dihydro-1,4-phthalazione; and combinations of phthalazine as well as phthalazine derivatives (e.g. 5-isopropyl phthalazine), and phthalic acid derivatives (e.g. phthalic acid, 4-methylphthalic acid, 4-nitrophthalic acid, and tetrachlorophthalic acid).

An amount of the compounds represented by the formula (I) or (II) in the invention is preferably used within a range of 10⁻⁴ mol to 1 mol per 1 mol of a non-sensitive silver salt in an image forming layer, more preferably used within a range of from 10⁻³ mol to 0.5 mol, and still further preferably used within a range of from 1×10⁻² mol to 0.3 mol.

As a manner for allowing a compound represented by the formula (I) or (II) of the invention to contain into a photothermographic material, there are those described in the manners for allowing the above-described reducing agents to contain into the photothermographic material. A compound soluble in water is preferably added in the form of a solution, while a compound insoluble in water is preferably added in the form of solid particle dispersion.

A compound represented by the formula (I) or (II) in the invention is preferably added to an image forming layer, a protective layer adjacent to the image forming layer, or an intermediate layer, and more preferable is to add the compound to the image forming layer.

(Plasticizer, Lubricant)

In the invention, well-known plasticizers and lubricants may be used for improving physical properties of a film. Particularly, a lubricant such as a liquid paraffin, a long chain fatty acid, a fatty amide, or a fatty ester is preferably used for the purpose of improving handling in manufacturing and scratch resistance in thermal development. Particularly preferable are liquid paraffin from which low-boiling components are removed and fatty esters with a branched structure and having 1000 or more molecular weight.

Concerning plasticizers and lubricants which may be used in an image forming layer and a non-photosensitive layer, compounds described in JP-A Nos. 11-65021 (Paragraph 0117), 2000-5137, 2004-219794, 2004-219802 and 2004-334077, the disclosures of which are incorporated by reference herein, are preferred.

(Dye and Pigment)

Various kinds of dyes and pigments such as C.I. Pigment Blues 60, 64, and 15:6 may be used in the image-forming layer for the purpose of improving the color tone, preventing generation of interference fringe upon laser exposure, and preventing irradiation. The dyes and pigments are described in detail, for example, in WO 98/36322, JP-A Nos. 10-268465 and 11-338098, the disclosures of which are incorporated by reference herein.

(Nucleating Agent)

It is preferable to incorporate a nucleating agent into the image-forming layer. Examples of the nucleating agents, examples of the methods for adding them, and examples of the amount thereof are described in JP-A No. 11-65021, Paragraph 0118; JP-A No. 11-223898, Paragraph 0136 to 0193; JP-A No. 2000-284399 (the compounds each represented by any one of the formulae (H), (1) to (3), (A), and (B)); JP-A No. 2000-347345 (the compounds represented by the formulae (III) to (V) and the example compounds of Chemical Formula 21 to 24); etc. Further, examples of nucleating accelerator are described in JP-A No. 11-65021, Paragraph 0102, and JP-A No. 11-223898, Paragraph 0194 and 0195.

Formic acid or a formate salt may be used as a strong fogging agent. The amount of the formic acid or the formate salt per 1 mol of silver is preferably 5 mmol or smaller, more preferably 1 mmol or smaller, on the image-forming layer side.

In the photothermographic material of the invention, the nucleating agent is preferably used in combination with an acid generated by hydration of diphosphorus pentaoxide or a salt thereof. Examples of the acid and the salt include metaphosphoric acid, pyrophosphoric acid, orthophosphoric acid, triphosphoric acid, tetraphosphoric acid, hexametaphosphoric acid, and salts thereof. Particularly preferred are orthophosphoric acid, hexametaphosphoric acid, and salts thereof. Specific examples of the salts include sodium orthophosphate, sodium dihydrogen orthophospate, sodium hexametaphosphate, and ammonium hexametaphosphate.

The amount of the acid generated by the hydration of diphosphorus pentaoxide or the salt thereof may be selected depending on the sensitivity, the fogging properties, etc. The amount of the acid or the salt to be applied per 1 m² of the photosensitive material is preferably 0.1 to 500 mg/m², more preferably 0.5 to 100 mg/m².

(Layer Constitution and Constitutional Components)

The photothermographic material of the invention includes at least one non-photosensitive layer in addition to the image forming layer. The non-photosensitive layers may be classified according to an arrangement thereof into (a) a surface protective layer on or above the image forming layer (further than the image forming layer from a support), (b) an intermediate layer disposed between a plurality of image forming layers, or disposed between an image forming layer and the protective layer, (c) an undercoat layer disposed between the image forming layer and the support, and (d) a back layer disposed on the side opposite to the image forming layer.

The surface protective layer may be either a single layer or plural layers. In the invention, it is preferred to provide a layer wherein 70% by mass or more of a binder is a hydrophilic binder as the outermost layer on the same side as the image forming layer.

Furthermore, a layer functions as an optical filter may be provided. In this case, the layer may be provided as the layer (a) or (b). An antihalation layer may be provided in the layer (c) or (d) of a photosensitive material.

1) Outermost Layer

A binder of the non-photosensitive layer in the invention contains 70% by mass or more of a hydrophilic polymer, preferably 80% by mass or more, and more preferably 90% by mass or more.

The hydrophilic polymer may be irrespective of being derived from an animal protein, but a water-soluble polymer derived from an animal protein is preferable in view of setting properties and an ability for trapping efficiently an organic acid produced.

<Hydrophilic Polymer Derived from Animal Protein>

In the invention, the hydrophilic polymer derived from an animal protein is a natural or chemically modified polymer such as glue, casein, gelatin, or albumen.

The hydrophilic polymer derived from an animal protein is preferably a gelatin or a gelatin derivative. Gelatins may be classified to acid-processed gelatins and alkali-processed gelatins such as lime-treated gelatins according to the synthesis methods, gelatins of both classes are usable in the invention. The gelatin used as the hydrophilic polymer preferably has a molecular weight of 10,000 to 1,000,000. The hydrophilic polymer derived from an animal protein may be a modified gelatin such as a phthalated gelatin, which is prepared by modifying the amino or carboxyl group of a gelatin.

An aqueous gelatin solution is converted to a sol when heated to a temperature of 30° C. or higher, and is converted to a gel and loses its fluidity when cooled to a temperature which is lower than 30° C. Since the sol-gel transformation is caused reversibly depending on the temperature, the aqueous gelatin solution of the coating liquid has a setting property, whereby it loses the fluidity when cooled to a temperature which is lower than 30° C.

The hydrophilic polymer derived from an animal protein may be used in combination with the hydrophilic polymer that is not derived from an animal protein and/or the hydrophobic polymer.

<Hydrophilic Polymer that is Not Derived from an Animal Protein>

The hydrophilic polymer that is not derived from an animal protein is a natural polymer other than the animal proteins (a polysaccharide, a microbial polymer, an animal polymer, etc.; for example a gelatin), a semisynthetic polymer (a cellulose-based polymer, a starch-based polymer, alginic-acid-based polymer, etc.), or a synthetic polymer (a vinyl-based polymer, etc.). Examples of the hydrophilic polymer that is not derived from an animal protein include synthetic polymers such as polyvinyl alcohols, and natural or semisynthetic polymers derived from plant cellulose, to be hereinafter described. The hydrophilic polymer that is not derived from an animal protein is preferably a polyvinyl alcohol or an acrylic acid-vinyl alcohol copolymer. The hydrophilic polymer that is not derived from an animal protein does not have a setting property. When the hydrophilic polymer that is not derived from an animal protein is used in a layer adjacent to an outermost layer, it is preferable to use in combination with a gelling agent.

The hydrophilic polymer that is not derived from an animal protein is preferably a polyvinyl alcohol (PVA). Specific examples of the polyvinyl alcohols include polyvinyl alcohols having various saponification degrees, polymerization degrees, and neutralization degrees, modified polyvinyl alcohols, and copolymers with other monomers.

The modified polyvinyl alcohol used as the hydrophilic polymer that is not derived from an animal protein may be a cation-modified, anion-modified, SH-compound-modified, alkylthio-compound-modified, or silanol-modified polyvinyl alcohol. The modified polyvinyl alcohols described in Koichi Nagano, et al., Poval, Kobunshi Kanko Kai may be used in the invention, the disclosures of which is incorporated herein by reference.

The viscosity of the aqueous solution of the polyvinyl alcohol can be adjusted or stabilized by adding trace of a solvent or inorganic salt, which is described in detail in Koichi Nagano, et al., Poval, Kobunshi Kanko Kai, Page 144 to 154. The disclosure of this literature is incorporated by reference herein in its entirety. As a typical example, boric acid can be added to the polyvinyl alcohol so as to improve the coated surface state. The mass ratio of the boric acid to the polyvinyl alcohol is preferably 0.01% by mass to 40% by mass.

The crystallinity of the polyvinyl alcohol can be increased by a heat treatment, thereby improving the waterproofness, as described in the above reference Poval. The waterproofness of the polyvinyl alcohol can be improved by being heated at the coating and drying or after the drying.

In order to further improve the waterproofness, a waterproofing agent such as those described in the above reference Poval, Page 256 to 261 is preferably added to the polyvinyl alcohol. Examples of the waterproofing agents include aldehydes; methylol compounds such as N-methylol urea and N-methylol melamine; activated vinyl compounds such as divinylsulfone and derivatives thereof; bis(β-hydroxyethylsulfone); epoxy compounds such as epichlorohydrin and derivatives thereof; polyvalent carboxylic acids such as dicarboxylic acids and polycarboxylic acids including polyacrylic acids, methyl vinyl ether-maleic acid copolymers, and isobutylene-maleic anhydride copolymers; diisocyanates; and inorganic crosslinking agents such as compounds of Cu, B, Al, Ti, Zr, Sn, V, Cr, etc.

In the invention, the waterproofing agent is preferably an inorganic crosslinking agent, more preferably boric acid or a derivative thereof, particularly preferably boric acid.

Specific examples of the hydrophilic polymer that is not derived from an animal protein include, in addition to the polyvinyl alcohols, the following polymers:
plant polysaccharides such as gum arabics, κ-carrageenans, τ-carrageenans, λ-carrageenans, guar gums (e.g. SUPERCOL manufactured by Squalon), locust bean gums, pectins, tragacanths, corn starches (e.g. PURITY-21 manufactured by National Starch & Chemical Co.), and phosphorylated starches (e.g. NATIONAL 78-1898 manufactured by National Starch & Chemical Co.);
microbial polysaccharides such as xanthan gums (e.g. KELTROL T manufactured by Kelco) and dextrins (e.g. NADEX 360 manufactured by National Starch & Chemical Co.);
animal polysaccharides such as sodium chondroitin sulfates (e.g. CROMOIST CS manufactured by Croda);
cellulose-based polymers such as ethylcelluloses (e.g. CELLOFAS WLD manufactured by I.C.I.), carboxymethylcelluloses (e.g. CMC manufactured by Daicel),
hydroxyethylcelluloses (e.g. HEC manufactured by Daicel), hydroxypropylcelluloses (e.g. KLUCEL manufactured by Aqualon), methylcelluloses (e.g. VISCONTRAN manufactured by Henkel), nitrocelluloses (e.g. Isopropyl Wet manufactured by Hercules), and cationated celluloses (e.g. CRODACEL QM manufactured by Croda);
alginic acid-based compounds such as sodium alginates (e.g. KELTONE manufactured by Kelco) and propylene glycol alginates; and
other polymers such as cationated guar gums (e.g. HI-CARE 1000 manufactured by Alcolac) and sodium hyaluronates (e.g. HYALURE manufactured by Lifecare Biomedial).

The specific examples of the hydrophilic polymer that is not derived from an animal protein further include agars, furcellerans, guar gums, karaya gums, larch gums, guar seed gums, psyllium seed gums, quince seed gums, tamarind gums, gellan gums, and tara gums. Among them, polymers which are highly water-soluble are preferable. The hydrophilic polymer that is not derived from an animal protein is preferably such a polymer that the aqueous solution thereof undergoes sol-gel transformation by temperature change between 5 to 95° C. within 24 hours.

Further, the hydrophilic polymer that is not derived from an animal protein may be a synthetic polymer, and specific examples thereof include acrylic polymers such as sodium polyacrylate, polyacrylic acid copolymers, polyacrylamide, and polyacrylamide copolymers; vinyl polymers such as polyvinylpyrrolidone and polyvinylpyrrolidone copolymers; and other synthetic polymers such as polyethylene glycol, polypropylene glycol, polyvinyl ether, polyethyleneimine, polystyrene sulfonate and copolymers thereof, polyvinyl sulfonate and copolymers thereof, polyacrylic acids and copolymers thereof, acrylic acids and copolymers thereof, maleic acid copolymers, maleic monoester copolymers, and acryloylmethylpropanesulfonic acid polymers and copolymers thereof.

Further, polymers with high water absorbability described in U.S. Pat. No. 4,960,681, JP-A No. 62-245260 (the disclosures of which are incorporated herein by reference), etc. may be used as the hydrophilic polymer that is not derived from an animal protein. Examples of the polymers with high water absorbability include homopolymers of vinyl monomers having a —COOM or —SO₃M group (in which M is a hydrogen or alkaline metal atom) such as sodium methacrylate, ammonium methacrylate, and Sumika Gel L-5H available from Sumitomo Chemical Co., Ltd, and copolymers of such vinyl monomers with other vinyl monomers.

Preferred hydrophilic polymer among them is SUMIKA GEL L-5H available from Sumitomo Chemical Co., Ltd.

<Gelling Agent and Gelation Accelerator>

The gelling agent used in the invention is such a substance that, when it is added to the aqueous solution of the hydrophilic polymer that is not derived from an animal protein and the solution is cooled, the solution is gelated. The gelling agent may be a substance which cause gelation when used in combination with a gelation accelerator. The fluidity of the solution is remarkably reduced by the gelation.

The gelling agent may be a water-soluble polysaccharide, and specific examples thereof include agars, κ-carrageenans, τ-carrageenans, alginic acid, alginate salts, agaroses, furcellerans, gellan gums, glucono delta lactones, azotobacter vinelandii gums, xanthan gums, pectins, guar gums, locust bean gums, tara gums, cassia gums, glucomannans, tragacanth gums, karaya gums, pullulans, arabic gums, arabinogalactans, dextrans, carboxymethylcellulose sodium salt, methylcelluloses, psyllium seed gums, starches, chitins, chitosans, and curdlans.

The agars, carrageenans, gellan gums, etc. can form the gel when they are heated and melted, and then cooled.

More preferred among these gelling agents are κ-carrageenans (e.g., K-9F available from Taito Co., Ltd., K-15, K-21 to 24, and I-3 available from Nitta Gelatin Inc., etc.), τ-carrageenans, and agars, and particularly preferred are κ-carrageenans.

The mass ratio of the gelling agent to the binder polymer is preferably 0.01 to 10.0% by mass, more preferably 0.02 to 5.0% by mass, further preferably 0.05 to 2.0% by mass.

The gelling agent is preferably used in combination with a gelation accelerator. The gelation accelerator used in the invention is such a substance that the gelation accelerator enhance the gelation when brought into contact with a specific gelling agent. A specific combination of the gelling agent and the gelation accelerator enables the gelation accelerator to perform its function. Examples of the combinations of the gelling agent and the gelation accelerator, usable in the invention, include the following ones:
i) a combination of a gelation accelerator selected from alkaline metal ions such as a potassium ion and alkaline earth metal ions such as a calcium ion and magnesium ion, and a gelling agent selected from carrageenan, alginate salts, gellan gum, azotobacter vinelandii gum, pectin, carboxymethylcellulose sodium salt, etc.;
ii) a combination of a gelation accelerator selected from boron compounds such as boric acid, and a gelling agent selected from guar gum, locust bean gum, tara gum, cassia gum, etc.;
iii) a combination of a gelation accelerator selected from acids and alkalis, and a gelling agent selected from alginate salts, glucomannan, pectin, chitin, chitosan, curdlan, etc.; and
iv) a combination of a gelling agent and a gelation accelerator selected from water-soluble polysaccharides capable of reacting with the gelling agent to form a gel, such as a combination of xanthan gum as a gelling agent and cassia gum as a gelation accelerator, and a combination of carrageenan as a gelling agent and locust bean gum as a gelation accelerator.

Specific examples of the combinations of the gelling agent and the gelation accelerator include the following combinations:
a) combination of κ-carrageenan and potassium;
b) combination of τ-carrageenan and calcium;
c) combination of low methoxyl pectin and calcium;
d) combination of sodium alginate and calcium;
e) combination of gellan gum and calcium;
f) combination of gellan gum and an acid; and
g) combination of locust bean gum and xanthan gum.

A plurality of the combinations may be used simultaneously.

The gelation accelerator and the gelling agent are preferably added to different layers though they may be added to the same layer. In an embodiment, the gelation accelerator is added to a layer which is not in contact with a layer containing the gelling agent. In this embodiment, a layer free from both of the gelling agent and the gelation accelerator is disposed between the layer containing the gelling agent and the layer containing the gelation accelerator.

The mass ratio of the gelation accelerator to the gelling agent is preferably 0.1 to 200% by mass, more preferably 1.0 to 100% by mass.

<Combined Use of Hydrophilic Polymer>

A binder in a non-photosensitive layer, a hydrophobic polymer may be added to the above-described hydrophilic polymer in a range which does not exceed 30% by mass. Hydrophobic polymers which can be used together are preferably polymers dispersible into an aqueous solvent.

An example of preferable polymers dispersible into a water-base solvent includes synthetic resins, polymers copolymers, and the other media which can form a film, such as cellulose acetates, cellulose acetate butyrates, poly(methylmethacrylic acids), poly(vinyl chlorides), poly(methacrylic acids), styrene-maleic anhydride copolymers, styrene-acrylonitrile copolymers, styrene-butadiene copolymers, poly(vinylacetals) (e.g. poly(vinyl formal) and poly(vinyl butyral)), poly(esters), poly(urethanes), phenoxy resins, poly(vinylidene chlorides), poly(epoxides), poly(carbonates), poly(vinyl acetates), poly(olefins), cellulose esters, and poly(amides).

<Amount of Binder to be Applied>

An application amount of the whole binder (including a hydrophilic polymer and a latex polymer) in the non-photosensitive layer is preferably 0.3 g/m² to 5.0 g/m², and more preferably 0.3 g/m² to 2.0 g/m².

<Additive>

A variety of additives other than the binder may be added to the non-photosensitive layer. An example of the additives includes surfactants, pH adjustors, preservatives, and fungicides.

Furthermore, when the non-photosensitive layer is a surface protective layer, it is preferred to use a lubricant such as liquid paraffins, and fatty esters. An amount of the lubricant to be used is within a range of from 1 mg/m² to 200 mg/m², preferably within a range of from 10 mg/m² to 150 mg/m², and more preferably within a range of from 20 mg/m² to 100 mg/m².

2) Antihalation Layer

In the photothermographic material of the invention, an antihalation layer may be disposed such that the antihalation layer is farther from the exposure light source than the image-forming layer is.

The antihalation layer is described, for example, in JP-A No. 11-65021, Paragraph 0123 to 0124, JP-A Nos. 11-223898, 9-230531, 10-36695, 10-104779, 11-231457, 11-352625, and 11-352626, the disclosures of which are incorporated herein by reference.

The antihalation layer includes an antihalation dye having absorption in the exposure wavelength range. When the exposure wavelength is within the infrared range, an infrared-absorbing dye may be used as the antihalation dye, and the infrared-absorbing dye is preferably a dye which does not absorb visible light.

When a dye having absorption in the visible light range is used to prevent the halation, in a preferable embodiment, the color of the dye does not substantially remain after image formation. It is preferable to achromatize the dye by heat at the heat development. In a more preferable embodiment, a base precursor and a thermally-achromatizable dye are added to a non-photosensitive layer so as to impart the antihalation function to the non-photosensitive layer. These techniques are described, for example in JP-A No. 11-231457, the disclosure of which is incorporated by reference herein.

The amount of the achromatizable dye to be applied may be determined depending on the purpose. Generally, the amount of the achromatizable dye is selected such that the optical density (the absorbance) exceeds 0.1 at the desired wavelength. The optical density is preferably 0.15 to 2, more preferably 0.2 to 1. The amount of the dye required for obtaining such an optical density is generally 0.001 to 1 g/m².

When the dye is achromatized in this manner, the optical density after the heat development can be lowered to 0.1 or lower. In an embodiment, two or more achromatizable dyes are used in combination in a thermally achromatizable recording material or a photothermographic material. Similarly, two or more base precursors may be used in combination.

In the thermal achromatization, it is preferable to use an achromatizable dye, a base precursor, and a substance which can lower the melting point of the base precursor by 3° C. or more when mixed with the base precursor, in view of the thermal achromatizability, as described in JP-A No. 11-352626, the disclosure of which is incorporated by reference herein. Examples of the substance include diphenylsulfone, 4-chlorophenyl(phenyl)sulfone, and 2-naphtyl benzoate.

2) Back Layer

Examples of the back layer usable in the invention are described in JP-A No. 11-65021, Paragraph 0128 to 0130, the disclosure of which is incorporated herein by reference.

In the invention, a coloring agent having an absorption peak within the wavelength range of 300 to 450 nm may be added to the photosensitive material so as to improve the color tone of silver and to suppress the image deterioration with time. Examples of the coloring agent are described in JP-A Nos. 62-210458, 63-104046, 63-103235, 63-208846, 63-306436, 63-314535, 01-61745, and 2001-100363, the disclosures of which are incorporated by reference herein.

Such coloring agent is usually added within a range of from 0.1 mg/m² to 1 g/m², and the coloring agent is preferably added to a back layer provided on the side opposite to an image forming layer.

Furthermore, preferable is to use a dye having an absorption peak of from 580 nm to 680 nm for adjusting a base color tone. As the dye for this purpose, preferable are azomethine-base oil-soluble dyes described in JP-A Nos. 4-359967 and 4-359968, and phthalocyanine-base water-soluble dyes described in Japanese Patent Application JP-A No. 2003-295388 having a low absorption intensity on a side of short wavelength. The disclosures of the above patent documents are incorporated by reference herein.

Although the dye for the above purpose may be added into any layer, more preferable is to add into a non-photosensitive layer on an emulsion side or a back surface side.

The photothermographic material of the invention is preferably a so-called single-sided photosensitive material, which comprises at least one image-forming layer including the silver halide emulsion on one side of the support, and a back layer on the other side of the support.

4) Matting Agent

In the invention, a matting agent is preferably added to improve the conveyability. The matting agent is described in JP-A No. 11-65021, Paragraph 0126 and 0127, the disclosure of which is incorporated herein by reference. The amount of the matting agent to be applied per 1 m² of the photosensitive material is preferably 1 to 400 mg/m², more preferably 5 to 300 mg/m².

The matting agent may be delomorphous or amorphous, and is preferably delomorphous. The matting agent is preferably in a sphere shape.

The volume-weighted average equivalent sphere diameter of the matting agent provided on the emulsion surface is preferably 0.01 to 10 μm, more preferably 0.01 to 7 μm. The variation coefficient of the particle size distribution of the matting agent is preferably 1 to 60%, more preferably 5 to 40%. The variation coefficient is obtained according to the equation:
variation coefficient=(standard deviation of particle diameter)/(average particle diameter)×100.

Further, two or more types of the matting agents having different average particle sizes may be provided on the emulsion surface. In this case, the difference of the average particle sizes between the smallest matting agent and the largest matting agent is preferably 0.05 to 10 μm, more preferably 0.05 to 7 μm.

The volume-weighted average equivalent sphere diameter of the matting agent provided on the back surface is preferably 1 to 20 μm, more preferably 3 to 15 μm. The variation coefficient of the particle size distribution of the matting agent is preferably 1 to 0.5%, more preferably 1 to 30%. Further, two or more types of the matting agents having different average particle sizes may be provided on the back surface. In this case, the difference of the average particle sizes between the smallest matting agent and the largest matting agent is preferably 1 to 15 μm, more preferably 2 to 12 μm.

In the invention, the matting agent is preferably included in a layer or layers selected from the outermost layer, a layer functioning as an outermost layer, a layer near the outermost layer, or a layer functioning as a protective layer.

5) Bekk Smoothness

The thermographic material of the invention is formulated such that an outside surface at the side having the image forming layer and outside surface at the back side respectively have Bekk smoothnesses within predetermined ranges. Adjustment of a Bekk smoothness is carried out based on not only types of binders in the respective outermost layers and the application amounts thereof, application amounts of matting agents and the materials, sizes and size distributions thereof, and additives such as plasticizers and lubricants, but also other complicated factors influenced by a composition of the image forming layer.

A Bekk smoothness can be easily determined in accordance with Japanese Industrial Standard (JIS) P8119 “Paper and board—Determination of smoothness by Bekk method” or TAPPI Standard Method T479, the disclosures of which are incorporated herein by reference.

A matting degree (Bekk smoothness) on a surface at the side having the image forming layer is 1000 seconds or more, preferably 2000 seconds to an infinite number of seconds, and more preferably 3000 seconds to an infinite number of seconds. A matting degree on a back surface is 5 seconds to 400 seconds, preferably 10 seconds to 400 seconds, and more preferably 20 seconds to 300 seconds. The the term “an infinite number of seconds” means that a measurement is impossible by the above-described tester.

6) Polymer Latex

When a photothermographic material of the invention is used for a printing use application wherein dimensional changes become particularly a problem, it is preferred to use a polymer latex in a surface protective layer or a back layer.

An example of such polymer latexes includes those described in “Synthetic Resin Emulsion” (edited by Taira Okuda and Hiroshi Inagaki, published from Koubunshi Kankou-kai (1978)); “Application for Synthetic Latex” (edited by Takaaki Sugimura, Yasuo Kataoka, Souichi Suzuki, and Keiji Kasahara, published from Koubunshi Kankou-kai (1993)); “Chemistry of Synthetic Latex” (authored by Souichi Muroi, published from Koubunshi Kankou-kai (1970)) and the like; and being specifically a latex of methyl methacrylate (33.5% by mass)/ethyl acrylate (50% by mass)/methacrylic acid (16.5% by mass) copolymer; a latex of methyl methacrylate (47.5% by mass)/butadiene (47.5% by mass)/itaconic acid (5% by mass) copolymer; a latex of ethyl acrylate/methacrylic acid copolymer; a latex of methyl methacrylate (58.9% by mass)/2-ethylhexyl acrylate (25.4% by mass)/styrene (8.6% by mass)/2-hydroxyethyl methacrylate (5.1% by mass)/acrylic acid (2.0% by mass) copolymer; and a latex of methyl methacrylate (64.0% by mass)/styrene (9.0% by mass)/butyl acrylate (20.0% by mass)/2-hydroxyethyl methacrylate (5.0% by mass)/acrylic acid (2.0% by mass) copolymer.

Moreover, to a binder for the surface protective layer, a technology described in Paragraphs 0021 to 0025 in JP-A No. 2000-267226, and a technology described in Paragraphs 0023 to 0041 in Japanese Patent Application Laid-Open No. 2000-19678 may be applied. The disclosures of the above patent documents are incorporated by reference herein.

A ratio of a polymer latex in the surface protective layer is preferably 10% by mass to 90% by mass, and particularly preferably 20% by mass to 80% by mass with respect to the whole binder.

7) Surface pH

The photothermographic material of the invention before heat development preferably has a surface pH of 7.0 or lower. The surface pH is more preferably 6.6 or lower. The lower limit of the surface pH may be approximately 3, though it is not particularly restricted. The surface pH is still more preferably 4 to 6.2. It is preferable to adjust the surface pH using an organic acid such as a phthalic acid derivative, a nonvolatile acid such as sulfuric acid, or a volatile base such as ammonia, from the viewpoint of lowering the surface pH. In order to achieve a low surface pH, it is preferable to use ammonia since ammonia is high in volatility and can be removed during coating or before heat development. It is also preferable to use ammonia in combination with a nonvolatile base such as sodium hydroxide, potassium hydroxide, or lithium hydroxide. Methods for measuring the surface pH are described in JP-A No. 2000-284399, Paragraph 0123, the disclosure of which is incorporated herein by reference.

8) Film Hardener

A film hardener may be included in layers such as the image-forming layer, the protective layer, and the back layer. Examples of the film hardeners are described in T. H. James, The Theory of the Photographic Process, Fourth Edition, Page 77 to 87 (Macmillan Publishing Co., Inc., 1977), the disclosure of which is incorporated by reference herein. Preferred examples of the film hardeners include chromium alums; 2,4-dichloro-6-hydroxy-s-triazine sodium salt; N,N-ethylenebis(vinylsulfonacetamide); N,N-propylenebis(vinylsulfonacetamide); polyvalent metal ions described in Page 78 of the above reference; polyisocyanates described in U.S. Pat. No. 4,281,060, JP-A No. 6-208193, etc.; epoxy compounds described in U.S. Pat. No. 4,791,042, etc.; and vinylsulfone compounds described in JP-A No. 62-89048, etc. The disclosures of the above patent documents are incorporated herein by reference.

The film hardener is added in the form of a solution, and the solution is added to the coating liquid for the protective layer preferably in the period of 180 minutes before coating to immediately before coating, more preferably in the period of 60 minutes before coating to 10 seconds before coating. The method and conditions of mixing the film hardener into the coating liquid are not particularly limited as long as the advantageous effects of the invention can be sufficiently obtained. In an embodiment, the film hardner is mixed with the coating liquid in a tank while controlling the addition flow rate and the feeding amount to the coater, such that the average retention time calculated from the addition flow rate and the feeding amount to the coater is the desired time. In another embodiment, the film hardner is mixed with the coating liquid by a method using a static mixer described, for example, in N. Harnby, M. F. Edwards, and A. W. Nienow, translated by Koji Takahashi, Ekitai Kongo Gijutsu, Chapter 8 (Nikkan Kogyo Shimbun, Ltd., 1989), the disclosure of which is incorporated herein by reference.

9) Surfactant

Surfactants described in JP-A No. 11-65021 (the disclosure of which is incorporated herein by reference in its entirety), Paragraph 0132, solvents described in ibid, Paragraph 0133, supports described in ibid, Paragraph 0134, antistatic layers and conductive layers described in ibid, Paragraph 0135, methods for forming color images described in ibid, Paragraph 0136, and slipping agents described in JP-A No. 11-84573 (the disclosure of which is incorporated herein by reference in its entirety), Paragraph 0061 to 0064 and JP-A No. 2001-83679 (the disclosure of which is incorporated herein by reference in its entirety) Paragraph 0049 to 0062, can be used in the invention.

In the invention, it is preferable to use a fluorochemical surfactants. Specific examples of the fluorochemical surfactants include compounds described in JP-A Nos. 10-197985, 2000-19680, and 2000-214554, the disclosures of which are incorporated herein by reference. Further, fluorine-containing polymer surfactants described in JP-A No. 9-281636 (the disclosure of which is incorporated herein by reference) are also preferable in the invention.

In an embodiment, the fluorochemical surfactants described in JP-A Nos. 2002-82411, 2003-057780, and 2003-149766 (the disclosures of which are incorporated herein by reference) are used in the photothermographic material of the invention. The fluorochemical surfactants described in JP-A Nos. 2003-057780 and 2003-149766 are particularly preferred from the viewpoints of the electrification control, the stability of the coated surface state, and the slipping properties in the case of using an aqueous coating liquid. The fluorochemical surfactants described in JP-A No. 2003-149766 are most preferred because they are high in the electrification control ability and are effective even when used in a small amount.

In the invention, the fluorochemical surfactant may be used in the emulsion surface and/or the back surface, and is preferably used in both the emulsion surface and/or the back surface. It is particularly preferable to use a combination of the fluorochemical surfactant and the above-described conductive layer including a metal oxide. In this case, sufficient performance can be achieved even if the fluorochemical surfactant in the electrically conductive layer side is reduced or removed.

The amount of the fluorochemical surfactant used in each of the emulsion surface and the back surface is preferably 0.1 to 100 mg/m², more preferably 0.3 to 30 mg/m², further preferably 1 to 10 mg/m². In particular, the fluorochemical surfactants described in JP-A No. 2003-149766 can exhibit excellent effects, whereby the amount thereof is preferably 0.01 to 10 mg/m², more preferably 0.1 to 5 mg/M².

10) Antistatic Agent

In the invention, it is preferred to provide an electroconductive layer containing a metallic oxide or an electroconductive polymer. An antistatic layer may be either served doubly as a undercoat layer, a back layer, a surface protective layer and the like, or may be separately provided. As an electroconductive material in an antistatic layer, a metallic oxide into which oxygen defect, heterometallic atoms are introduced to elevate electroconductivity is preferably used. A preferred example of the metallic oxide includes ZnO, TiO₂, and SnO₂. It is preferred that Al or In is added to ZnO, that Sb, Nb, P, halogen elements or the like is added to SnO₂, and that Nb, Ta or the like is added to TiO₂. Particularly preferable is SnO₂ to which Sb is added. An amount of a heteroatom to be added is preferably within a range of from 0.01 mol % to 30 mol %, and more preferably within a range of from 0.1 mol % to 10 mol %.

Although the metallic oxide may have any shape of sphere, needle-like, and plate-like, preferable are needle-like particles each having a major axis/minor axis ratio of 2.0 or more, and preferably 3.0 to 50.

An amount of the metallic oxide to be used is preferably within a range of 1 mg/m² to 1000 mg/m², more preferably within a range of 10 mg/m² to 500 mg/m², and still further preferably within a range of 20 mg/m² to 200 mg/m².

Although an antistatic layer in the invention may be provided on either side of an emulsion surface and a back surface, it is preferred to dispose the antistatic layer in between a substrate and the back layer. Specific examples of the antistatic layer are described in Paragraph 0135 of JP-A No. 11-65021, JP-A Nos. 56-143430, 56-143431, 58-62646, and 56-120519, Paragraphs 0040 to 0051 of JP-A No. 11-84573, U.S. Pat. No. 5,575,957, and Paragraphs 0078 to 0084 of JP-A No. 11-223898. The disclosures of the above patent documents are incorporated by reference herein.

11) Support

The support comprises preferably a heat-treated polyester, particularly a polyethylene terephthalate, which is subjected to a heat treatment at 130 to 185° C. so as to relax the internal strains of the film generated during biaxial stretching, thereby eliminating the heat shrinkage strains during heat development. In the case of a photothermographic material for medical use, the support may be colored with a blue dye (e.g., Dye-1 described in Examples of JP-A No. 8-240877, the disclosure of which is incorporated herein by reference) or uncolored. The support is preferably undercoated, for example, with a water-soluble polyester described in JP-A No. 11-84574, a styrene-butadiene copolymer described in JP-A No. 10-186565, a vinylidene chloride copolymer described in JP-A No. 2000-39684 or Japanese Patent Application No. 11-106881, Paragraph 0063 to 0080, the disclosures of which are incorporated herein by reference. When the support is coated with the image-forming layer or the back layer, the support preferably has a moisture content of 0.5% by mass or lower.

12) Other Additives

The photothermographic material of the invention may further include additives such as antioxidants, stabilizing agents, plasticizers, UV absorbers, and coating aids. The additives may be added to any one of the image-forming layer and the non-photosensitive layers. The additives may be used with reference to WO 98/36322, EP 803764A1, JP-A Nos. 10-186567 and 10-18568, the disclosures of which are incorporated herein by reference.

13) Coating Method

The photothermographic material of the invention may be formed by any coating method. Specific examples of the coating method include extrusion coating methods, slide coating methods, curtain coating methods, dip coating methods, knife coating methods, flow coating methods, extrusion coating methods using a hopper described in U.S. Pat. No. 2,681,294, the disclosure of which is incorporated herein by reference. The coating method is preferably an extrusion coating method described in Stephen F. Kistler and Petert M. Schweizer, Liquid Film Coating, Page 399 to 536 (CHAPMAN & HALL, 1997) (the disclosure of which is incorporated herein by reference), or a slide coating method, more preferably a slide coating method. Examples of slide coaters for the slide coating methods are described in the above reference, Page 427, FIG. 11b.1. Two or more layers may be simultaneously formed by any of methods described in the above reference, Page 399 to 536, and methods described in U.S. Pat. No. 2,761,791 and British Patent No. 837,095, the disclosures of which are incorporated herein by reference. Particularly preferred coating methods used in the invention include those described in JP-A Nos. 2001-194748, 2002-153808, 2002-153803, and 2002-182333, the disclosures of which are incorporated herein by reference.

In the invention, the coating liquid for the image-forming layer is preferably a so-called thixotropy fluid. The thixotropy fluid may be used with reference to JP-A No. 11-52509, the disclosure of which is incorporated herein by reference. The viscosity of the coating liquid for the image-forming layer is preferably 400 to 100,000 mPa·s at a shear rate of 0.1 S⁻¹, more preferably 500 to 20,000 mPa·s at a shear rate of 0.1 S⁻¹. Further, the viscosity of the coating liquid is preferably 1 to 200 mPa·s at a shear rate of 1,000 S⁻¹, more preferably 5 to 80 mPa·s at the shear rate of 1,000 S⁻¹.

In the preparation of the coating liquid, it is preferable to use a known in-line mixing apparatus or a known in-plant mixing apparatus when two or more liquids are mixed. An in-line mixing apparatus described in JP-A No. 2002-85948 and an in-plant mixing apparatus described in JP-A No. 2002-90940 can be preferably used in the invention. The disclosures of the above patent documents are incorporated by reference herein.

The coating liquid is preferably subjected to a defoaming treatment to obtain an excellent coated surface state. Preferred methods for the defoaming treatment are described in JP-A No. 2002-66431, the disclosure of which is incorporated herein by reference.

In or before the application of the coating liquid, the support is preferably subjected to electrical neutralization so as to prevent adhesion of dusts, dirts, etc. caused by the electrification of the support. Preferred examples of the neutralizing methods are described in JP-A No. 2002-143747, the disclosure of which is incorporated herein by reference.

When a non-setting type coating liquid for the image-forming layer is dried, it is important to precisely control drying air and drying temperature. Preferred drying methods are described in detail in JP-A Nos. 2001-194749 and 2002-139814, the disclosures of which are incorporated herein by reference.

The photothermographic material of the invention is preferably heat-treated immediately after coating and drying, so as to increase the film properties. In a preferable embodiment, the heating temperature of the heat treatment is controlled such that the film surface temperature is 60 to 100° C. The heating time is preferably 1 to 60 seconds. The film surface temperature in the heat treatment is more preferably 70 to 90° C., and the heating time is more preferably 2 to 10 seconds.

Preferred examples of the heat treatments are described in JP-A No. 2002-107872, the disclosure of which is incorporated herein by reference.

Further, the production methods described in JP-A Nos. 2002-156728 and 2002-182333 (the disclosures of which are incorporated herein by reference) can be preferably used to stably produce the photothermographic material of the invention continuously.

The photothermographic material of the invention is preferably a monosheet type material, which can form an image on the material without using another sheet such as an image-receiving material.

14) Packaging Material

It is preferable to seal the photosensitive material of the invention by a packaging material having a low oxygen permeability and/or a low water permeability so as to prevent deterioration of the photographic properties during storage or to prevent curling. The oxygen permeability is preferably 50 ml/atm·m²·day or lower at 25° C., more preferably 10 ml/atm·m²·day or lower at 25° C., furthermore preferably 1.0 ml/atm·m²·day or lower at 25° C. The water permeability is preferably 10 g/atm·m²·day or lower, more preferably 5 g/atm·m²·day or lower, furthermore preferably 1 g/atm·m²·day or lower.

Specific examples of the packaging material having a low oxygen permeability and/or a low water permeability include materials described in JP-A Nos. 8-254793 and 2000-206653, the disclosures of which are incorporated herein by reference.

15) Other Technologies

Other technologies usable for the photothermographic material of the invention include those described in EP 803764A1, EP 883022A1, WO 98/36322, and JP-A Nos. 56-62648, 58-62644, 9-43766, 9-281637, 9-297367, 9-304869, 9-311405, 9-329865, 10-10669, 10-62899, 10-69023, 10-186568, 10-90823, 10-171063, 10-186565, 10-186567, 10-186569 to 10-186572, 10-197974, 10-197982, 10-197983, 10-197985 to 10-197987, 10-207001, 10-207004, 10-221807, 10-282601, 10-288823, 10-288824, 10-307365, 10-312038, 10-339934, 11-7100, 11-15105, 11-24200, 11-24201, 11-30832, 11-84574, 11-65021, 11-109547, 11-125880, 11-129629, 11-133536 to 11-133539, 11-133542, 11-133543, 11-223898, 11-352627, 11-305377, 11-305378, 11-305384, 11-305380, 11-316435, 11-327076, 11-338096, 11-338098, 11-338099, 11-343420, 2001-200414, 2001-234635, 2002-020699, 2001-275471, 2001-275461, 2000-313204, 2001-292844, 2000-324888, 2001-293864, 2001-348546, and 2000-187298, the disclosures of which are incorporated herein by reference.

In the case a multi-color photothermographic material, the image-forming layers are generally separated from each other by providing functional or non-functional barrier layers between them as described in U.S. Pat. No. 4,460,681, the disclosure of which is incorporated herein by reference.

The multicolor photothermographic material may comprise a combination of the two layers for each color or a single layer including all the components as described in U.S. Pat. No. 4,708,928, the disclosure of which is incorporated herein by reference.

(Image Forming Method)

1) Exposure

The Exposure light source may be a red to infrared light emission He—Ne laser, a red semiconductor laser, or a blue to green light emission Ar⁺, He—Ne or He—Cd laser, or a blue semiconductor laser. Preferable is a red to infrared semiconductor laser wherein a peak wavelength of a laser beam is in 600 nm to 900 nm, and preferably in 620 nm to 850 nm. More preferable is an infrared semiconductor laser (780 nm, 810 nm) since its laser power is a high power, a photothermographic material of the invention can be made transparent, and other reasons.

On one hand, particularly a module wherein an SHG (Second Harmonic Generator) device is integrated with a semiconductor laser, and a blue semiconductor laser have been developed in recent years, so that a laser output device of a short-wavelength region has got a lot of attention. Such blue semiconductor laser is expected to expand demands in future in view of a possibility of highly fine image recording, an increase in a recording density, and a long life and stable output. A peak wavelength of such blue laser beam is preferably in 300 nm to 500 nm, and particularly preferable is in 400 nm to 500 nm.

It is also preferred that a laser beam is oscillated in a longitudinally multiple mode by means of high-frequency magnificence and the like.

2) Thermal Development

Although a photothermographic material of the invention may be developed by any method, the photothermographic material which was exposed in image-wise is usually developed by raising its temperature. A developing temperature is preferably from 80° C. to 25° C., more preferably from 100° C. to 140° C., and even more preferably from 110° C. to 130° C. A developing time is preferably from 1 second to 60 seconds, more preferably from 3 to 30 seconds, even more preferably from 5 to 25 seconds, and particularly preferably from 7 to 15 seconds.

A conveying rate of the photothermographic material in a thermal development section (thermal developing linear speed) is preferably 20 mm/sec to 50 mm/sec, and more preferably 35 mm/sec to 50 mm/sec.

As a method for thermal development, either of a drum type heater and a plate type heater may be used, but it is preferred to use the drum type heater.

It is preferred that a heater can be more stably controlled in order to downsize the heater and to reduce a thermal development time. Furthermore, it is desired that an exposure is started from a head in a sheet of photosensitive material, and a thermal development is also started before the rear end of the photosensitive material is exposed.

An imager which can conduct a speedy treatment preferred for the invention may be any of those described in JP-A Nos. 2002-289804 and 2002-287668. When the imager described is applied, a thermal developing treatment can be completed in 14 seconds with a three-stage plate type heater controlled at, for example, 107° C.-121° C.-121° C., so that a period of time required for outputting the first sheet can be reduced to 60 seconds.

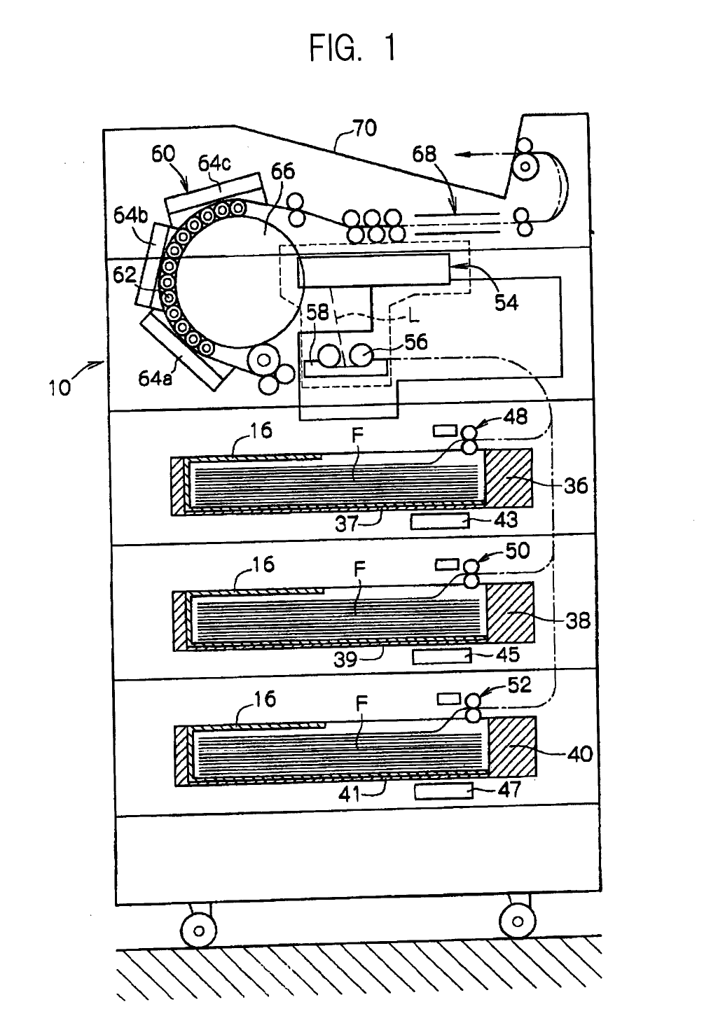

A thermal development apparatus provided with a preferred drum type heater in the invention is shown in FIG. 1. Reference character 10 designates an image recording device; 16 a cover sheet; 36, 38, and 40 trays, respectively; 37, 39, and 41 windows for reading bar codes, respectively; 43,45, and 47 bar code readers, respectively; 48, 50, and 52 sheet mechanisms, respectively; 54 an image recording section, 56 rollers; 58 a plate; 60 a roller unit; 62 rollers; 64a, 64b, and 64c roller pressers, respectively; 66 a heater drum; 68 a cooling section; 70 a discharging section; F films, and L a laser beam, respectively.

It is preferred that a heating treatment is carried out by allowing a surface of an image forming layer on the side having a protective layer to be in contact with a heater from viewpoints of uniform heating, heat efficiency, workability and the like. Moreover, a desirable development is such that a photothermographic material is heat-treated by conveying the material while the above-described surface is allowed to be in contact with the heater.

3) System

An example of a laser imager for medical application provided with an exposure section and a thermal development section includes Fuji Medical Dry Laser Imager FM-DPL and DRYPIX 7000, and Dry View 8700 Laser Imager Plus manufactured by Kodak Corporation. The FM-DPL is described in pages 39 to 55, No. 8 of Fuji Medical Review, the disclosure of which is incorporated by reference herein, the technology thereof is applied as a laser imager for the photothermographic material of the invention, as a matter of course. Furthermore, the photothermographic material is applicable for a laser imager in an “AD network” proposed as a network system being well adapted to DICOM standards by Fuji Film Medical Co., Ltd.

(Use of Photothermographic Material)

The photothermographic material according to the invention is preferably used for forming a black and white image of silver, and is preferably used for medical diagnosis, industrial photographs, printings, or COM, particularly preferably for medical diagnosis.

### EXAMPLES

The present invention will be described below with reference to Examples without intention of restricting the scope of the invention.

### Example 1

(Preparation of PET Support)

1) Film Formation

A PET having an intrinsic viscosity IV of 0.66, which was measured in a 6/4 mixture (mass ratio) of phenol/tetrachloroethane at 25° C., was prepared from terephthalic acid and ethylene glycol by a common procedure. The PET was converted to a pellet, dried at 130° C. for 4 hours, melted at 300° C., extruded from a T-die, and rapidly cooled to prepare an unstretched film.

The film was stretched 3.3 times in the longitudinal direction at 110° C. by rollers with different peripheral speeds, and then stretched 4.5 times in the horizontal direction at 130° C. by a tenter. The stretched film was subjected to thermal fixation at 240° C. for 20 seconds, and relaxed by 4% in the horizontal direction at this temperature. Then, the chuck of the tenter was slit, the both ends of the film were knurled, and the film was rolled up into 4 kg/cm², to obtain a roll having a thickness of 175 μm.

2) Surface Corona Treatment

Both surfaces of the support were treated at the room temperature at 20 m/minute using a solid state corona treatment machine Model 6KVA manufactured by Piller Inc. The electric current and voltage were read in the treatment, whereby it was found that the support was treated under the condition of 0.375 kV·A·minute/m². The discharging frequency of the treatment was 9.6 kHz, and the gap clearance between the electrode and the dielectric roll was 1.6 mm.

3) Undercoating

Prescription (1) for an Undercoat Layer on the Image-Forming Layer Side

46.8 g of PESRESIN A-520 (30% by mass solution) available from Takamatsu Oil & Fat Co., Ltd.
10.4 g of VYLONAL MD-1200 available from Toyobo Co., Ltd.
11.0 g of a 1% by mass solution of polyethylene glycol monononyl phenyl ether (average ethylene oxide number 8.5)
0.91 g of MP-1000 (fine PMMA polymer grains, average grain diameter 0.4 μm) available from Soken Chemical & Engineering Co., Ltd.
931 ml of distilled water
   Prescription (2) for a First Back Undercoat Layer
130.8 g of a styrene-butadiene copolymer latex (solid content 40% by mass, styrene/butadiene mass ratio 68/32)
5.2 g of an 8% by mass aqueous solution of 2,4-Dichloro-6-hydroxy-S-triazine sodium salt
10 ml of a 1% by mass aqueous solution of sodium laurylbenzenesulfonate
0.5 g of a polystyrene grain dispersion (average grain diameter 2 μm, 20% by mass)
854 ml of distilled water
   Prescription (3) for a Second Back Undercoat Layer
84 g of a 17% by mass dispersion of SnO₂/SbO (9/1 mass ratio, average grain diameter 0.5 μm)
7.9 g of gelatin
10 g of METOLOSE TC-5 (2% by mass aqueous solution) available from Shin-Etsu Chemical Co., Ltd.
10 ml of a 1% by mass aqueous solution of sodium dodecylbenzenesulfonate
7 g of a 1% by mass NaOH
0.5 g of PROXEL available from Avecia Ltd.
881 ml of distilled water

After subjecting the both surfaces of the biaxially stretched polyethylene terephthalate support having a thickness of 175 μm to the corona treatment, the undercoating liquid of Prescription (1) was applied to one surface (the image-forming side) of the support by a wire bar in a wet amount of 6.6 ml/m², and dried at 180° C. for 5 minutes. Then, the undercoating liquid of Prescription (2) was applied to the other surface (back surface) by a wire bar in a wet amount of 5.7 ml/m², and dried at 180° C. for 5 minutes. Further, the undercoating liquid of Prescription (3) was applied to the back surface by a wire bar in a wet amount of 8.4 ml/m², and dried at 180° C. for 6 minutes, to prepare an undercoated support.

(Back Layer)

1) Preparation of Back Layer Coating Liquid

<<Preparation of Dye D dispersion>>

250 grams of water was added to 15 g of the dye A and 6.4 g of DEMOHR N (trade name, manufactured by Kao Corporation), and mixed sufficiently to obtain a slurry. 800 grams of zirconia beads having 0.5 mm average diameter was prepared and placed in a vessel together with the slurry. The mixture was dispersed by a disperser (¼ G sand grinder mill manufactured by Aimex Co., Ltd.) for 25 hours, and water was added such that a dye concentration was adjusted to 5% by mass, to obtain a dye dispersion.

<<Preparation of Antihalation Layer Coating Liquid>>

A container was kept warm at 40° C., into which 37 g of gelatin having 4.8 isoelectric point (trade name: PZ gelatin manufactured by Miyagi Chemical Industry Co., Ltd.), 0.1 g of benzoisothiazolinone, and water were placed to dissolve the gelatin. Furthermore, to the dissolved gelatin, 43 ml of 3% by mass aqueous solution of polystyrene sodium sulfonate, 82 g of 10% by mass SBR latex (styrene/butadiene/acrylic acid copolymer; a mass ratio 68.3/28.7/3.0) liquid, and 40 g of the dye A dispersion were added to prepare an antihalation layer coating liquid.

2) Preparation of Back Protective Layer Coating Liquid

A container was kept warm at 40° C., into which 43 g of gelatin having 4.8 isoelectric point (trade name: PZ gelatin manufactured by Miyagi Chemical Industry Co., Ltd.), 0.21 g of benzoisothiazolinone, and water were placed to dissolve the gelatin. Furthermore, with the dissolved gelatin, 8.1 ml of 1 mol/liter sodium acetate aqueous solution, a matting agent (types and amounts added are indicated in Table 1, respectively), 5 g of 10% by mass emulsion of liquid paraffin, 10 g of 10% by mass emulsion of hexaisostearic acid dipentaerythritol emulsion, 10 ml of 5% by mass aqueous solution of sulfosuccinic acid di(2-ethylhexyl) sodium salt, 17 ml of 3% by mass aqueous solution of polystyrene sodium sulfonate, 2.4 ml of 2% by mass solution of a fluorine-base surfactant (F-1), 2.4 ml of 2% by mass solution of a fluorine-base surfactant (F-2), and 30 ml of 20% by mass liquid of ethyl acrylate/acrylic acid copolymer (a copolymerization mass ratio 96.4/3.6) latex were admixed. Immediately before coating, 50 ml of 4% by mass aqueous solution of N,N-ethylenebis(vinylsulfone acetamide) were admixed with the above-described mixture to obtain 855 ml of a completed liquid amount of a back protective layer coating liquid.
A matting agent A (PMMA particles, average particle size 8.5 μm, standard deviation of particle diameter 1.5 μm)
A matting agent B (PMMA particles, average particle size 0.07 μm, standard deviation of particle diameter 0.025 μm)
A matting agent C (PMMA particles, average particle size 12 μm, standard deviation of particle diameter 4.5 μm) 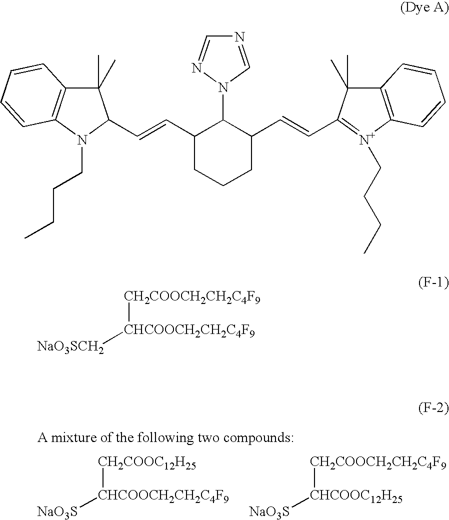
   3) Application of Back Layer

The back surface of the undercoated support was subjected to simultaneous multilayer coating with the antihalation layer coating liquid and the back protective layer coating liquid, and the applied liquids were dried to form a back layer. The antihalation layer coating liquid was applied such that the application amount of the gelatin was 1.0 g/m², and the back protective layer coating liquid was applied such that the application amount of the gelatin was 1.0 g/m².

(Image-Forming Layer and Surface Protective Layer)

1. Preparation of Coating Materials

1) Silver Halide Emulsion

<<Preparation of Silver Halide Emulsion 1>>

3.1 ml of a 1% by mass potassium bromide solution was added to 1421 ml of distilled water, and 3.5 ml of a 0.5 mol/l sulfuric acid solution and 31.7 g of phthalated gelatin were further added thereto. While stirring the resulting liquid in a stainless reaction pot at 30° C., a solution A prepared by diluting 22.22 g of silver nitrate with distilled water into 95.4 ml and a solution B prepared by diluting 15.3 g of potassium bromide and 0.8 g of potassium iodide with distilled water into 97.4 ml were added to the liquid at the constant flow rate over 45 seconds. Then, 10 ml of a 3.5% by mass aqueous hydrogen peroxide solution was added to the resultant mixture, and 10.8 ml of 10% by mass aqueous benzoimidazole solution was further added. Further, a solution C prepared by diluting 51.86 g of silver nitrate with distilled water to 317.5 ml and a solution D prepared by diluting 44.2 g of potassium bromide and 2.2 g of potassium iodide with distilled water to 400 ml were added to the mixture. The solution C was added over 20 minutes at a constant flow rate, and the solution D was added by a controlled double jet method while adjusting the pAg value to 8.1. 10 minutes after starting the addition of the solutions C and D, potassium hexachloroiridate (III) was added to the mixture in an amount of 1×10⁻⁴ mol per 1 mol of silver. Further, 5 seconds after completing the addition of the solution C, an aqueous solution of potassium iron (II) hexacyanide was added to the mixture in an amount of 3×10⁻⁴mol per 1 mol of silver. The pH value of the resulting mixture was adjusted to 3.8 using a 0.5 mol/l sulfuric acid, then the stirring was stopped, and the mixture was subjected to precipitation, desalination, and water-washing. The pH value of the mixture was adjusted to 5.9 using a 1 mol/l sodium hydroxide to prepare a silver halide dispersion 1 with pAg of 8.0.

5 ml of a 0.34% by mass methanol solution of 1,2-benzoisothiazoline-3-one was added to the silver halide dispersion 1 while stirring the dispersion at 38° C., and 40 minutes after the addition, the resulting mixture was heated to 47° C. 20 minutes after the heating, a methanol solution of sodium benzenethiosulfonate was added to the mixture in an amount of 7.6×10⁻⁵ mol per 1 mol of silver. Further, 5 minutes after the addition, a methanol solution of the tellurium sensitizer C shown below was added to the mixture in an amount of2.9×10⁻⁴ mol per 1 mol of silver, and the mixture was ripened for 91 minutes. A methanol solution of a 3/1 mole ratio mixture of the spectrally sensitizing dyes A and B was added to the mixture such that the total amount of the dyes A and B was 1.2×10⁻³ mol per 1 mol of silver. 1 minute after the addition, 1.3 ml of a 0.8% by mass methanol solution of N,N′-dihydroxy-N″-diethylmelamine was added to the mixture, and 4 minutes after the addition, a methanol solution of 5-methyl-2-mercaptobenzoimidazole, a methanol solution of 1-phenyl-2-heptyl-5-mercapto-1,3,4-triazole, and an aqueous solution of 1-(3-methylureidophenyl)-5-mercaptotetrazole were added thereto to prepare a silver halide emulsion 1. The amounts of 5-methyl-2-mercaptobenzoimidazole, 1-phenyl-2-heptyl-5-mercapto-1,3,4-triazole, and 1-(3-methylureidophenyl)-5-mercaptotetrazole were 4.8×10⁻³ mol, 5.4×10⁻³ mol, and 8.5×10⁻³ mol, per 1 mol of silver, respectively.

The prepared silver halide emulsion comprised silver iodobromide grains, which had an average equivalent sphere diameter of 0.042 μm and an equivalent sphere diameter variation coefficient of 20%, and included 3.5 mol % of iodo uniformly. The grain diameter, etc. was an average value of 1,000 grains obtained using an electron microscope. The grains had a {100} face proportion of 80%, obtained by the Kubelka-Munk method.

<<Preparation of Silver Halide Emulsion 2>>

A silver halide dispersion 2 was prepared in the same manner as the silver halide dispersion 1 except that the liquid temperature was changed from 30° C. to 47° C. in the grain formation, the solution B was prepared by diluting 15.9 g of potassium bromide with distilled water to 97.4 ml, the solution D was prepared by diluting 45.8 g of potassium bromide with distilled water to 400 ml, the solution C was added over 30 minutes, and potassium iron (II) hexacyanide was not used. The precipitation, desalination, water-washing, and dispersion were carried out in the same manner as the preparation of the silver halide dispersion 1. Further, the silver halide dispersion 2 was subjected to the steps of the spectral sensitization, the chemical sensitization, and the addition of 5-methyl-2-mercaptobenzoimidazole and 1-phenyl-2-heptyl-5-mercapto-1,3,4-triazole in the same manner as the preparation of the silver halide emulsion 1 except that the amount of the tellurium sensitizer C was 1.1×10⁻⁴ mol, methanol solution of a 3/1 mol ratio mixture of the spectrally sensitizing dyes A and B was added such that the total amount of the sensitizing dyes A and B was 7.0×10⁻⁴ mol, the amount of 1-phenyl-2-heptyl-5-mercapto-1,3,4-triazole was 3.3×10⁻³ mol, and the amount of 1-(3-methylureidophenyl)-5-mercaptotetrazole was 4.7×10⁻³ mol, per 1 mol of silver, to prepare a silver halide emulsion 2. The silver halide emulsion 2 comprised cuboidal pure silver bromide grains having an average equivalent sphere diameter of 0.080 μm and an equivalent sphere diameter variation coefficient of 20%.

<<Preparation of Silver Halide Emulsion 3>>

A silver halide dispersion 3 was prepared in the same manner as the silver halide dispersion 1 except that the liquid temperature was changed from 30° C. to 27° C. in the grain formation. The precipitation, desalination, water-washing, and dispersion were carried out in the same manner as the preparation of the silver halide dispersion 1. Then, a silver halide emulsion 3 was prepared from the silver halide dispersion 3 in the same manner as the preparation of the silver halide emulsion 1 except that a solid dispersion (an aqueous gelatin solution) of a 1/1 mole ratio mixture of the spectrally sensitizing dyes A and B was added such that the total amount of the dyes A and B was 6×10⁻³ mol per 1 mol of silver, the amount of the tellurium sensitizer C was 5.2×10⁻⁴ mol per 1 mol of silver, and 3 minutes after the addition of the tellurium sensitizer, 5×10⁻⁴ mol of bromoauric acid and 2×10⁻³ mol of potassium thiocyanate were added per 1 mol of silver. The prepared silver halide emulsion 3 comprised silver iodobromide grains, which had an average equivalent sphere diameter of 0.034 μm and an equivalent sphere diameter variation coefficient of 20%, and included 3.5 mol % of iodo uniformly.

<<Preparation of Mixed Emulsion A for Coating Liquid>>

70% by mass of the silver halide emulsion 1, 15% by mass of the silver halide emulsion 2, and 15% by mass of the silver halide emulsion 3 were mixed, and a 1% by mass aqueous solution of benzothiazolium iodide was added to the mixed emulsion such that the amount of benzothiazolium iodide was 7×10⁻³ mol per 1 mol of silver.

Water was added to the mixed emulsion for the coating liquid such that the silver amount of the silver halide was 38.2 g per 1 kg of the mixed emulsion. Further, 1-(3-methylureidophenyl)-5-mercaptotetrazole was added such that the amount thereof was 0.34 g per 1 kg of the mixed emulsion.

2) Preparation of Fatty Acid Silver Dispersion

<<Preparation of Recrystallized Behenic Acid>>

100 kg of behenic acid (trade name: EDENOR C22-85R, manufactured by Henkel Corporation) was mixed with 120 kg of isopropyl alcohol, dissolved at 50° C., filtrated with a 10 μm filter, and cooled to 30° C. to recrystallize the behenic acid. A cooling speed for the recrystallization was controlled to 3° C./hour. The resulting crystals were subjected to centrifugal filtration, 100 kg of isopropyl alcohol was poured on the crystals thus filtrated to wash them, and then dried. The resulting crystals were esterified, and the product was subjected to GC-FID measurement. As a result, a content of behenic acid was 96 mol %, and the other products were 2 mol % lignoceric acid, 2 mol % arachidic acid, and 0.001 mol % erucic acid.

<<Preparation for Nanoparticles of Silver Behenate>>

First, a reactor was charged with deionized water, 10% solution of a dodecylthiopolyacrylamide surfactant (72 g) and the above-described recrystallized behenic acid (46.6 g). The contents of the reactor were stirred at 150 rpm, heated to 70° C., and during which 10% by mass of KOH solution (70.6 g) was introduced in the reactor. Then, the contents in the reactor were heated at 80° C., and maintained for 30 minutes until the contents become turbid. Thereafter, the reaction mixture was cooled to 70° C., and a silver nitrate solution (21.3 g of 100% solution) made of silver nitrate was added for 30 minutes while adjusting a period of time for the addition. Then, the contents in the reactor was maintained for 30 minutes at the reaction temperature, cooled to a room temperature, and then decanted. As a result, a nanoparticle silver behenate dispersion having 150 nm median particle size was obtained (3% solid content).

<<Purification and Concentration of Nanoparticle Silver Behenate>>

A nanoparticle silver behenate dispersion of 3% by mass solid content (12 kg) was placed in a diarfiltration/ultrafiltration apparatus (provided with “Osmonics” Model 21-HZ20-S8J permeable membrane cartridge having 0.34 m² effective surface area and 50,000 nominal molecular weight cut-off). The apparatus was operated in such that a pressure applied to the permeable membrane was 3.5 kg/cm², and a pressure on the downstream side was 20 kg/cm². Until 24 kg of a sokage is removed from the dispersion, the soakage was replaced by deionized water (replacement water). When an amount of the soakage reached 24 kg, a feed of the replacement water was stopped, and then, the apparatus was operated until a concentration of the dispersion reaches 28% by mass solid content to obtain a nanoparticle silver behenate dispersion.

3) Preparation of Reducing Agent Dispersion

10 kg of water was added to 10 kg of a reducing agent-1 (6,6′-di-t-butyl-4,4′-dimethyl-2,2′-butylidenediphenol) and 16 kg of 10% by mass aqueous solution of modified polyvinyl alcohol (trade name: POVAL MP203, manufactured by Kraray Co., Ltd.), and admixed sufficiently to prepare a slurry. The slurry was fed with a diaphragm pump to a horizontal sand mill (trade name: UVM-2, manufactured by Aimex Co., Ltd.), dispersed therein for 3 hours, and then, 0.2 g of benzoisothiazolinone sodium salt and water were added to adjust in such that a concentration of the reducing agent became 25% by mass. The resulting dispersion was heat-treated at 60° C. for 5 hours to obtain a reducing agent-1 dispersion. Reducing agent particles contained in the resulting reducing agent dispersion had 0.40 μm median diameter and 1.4 μm or less the maximum particle diameter.

The resulting reducing agent dispersion was filtrated by a propylene filter of 3.0 μm pore diameter to remove foreign matters such as dust, and the resulting product was stored.

4) Preparation of Polyhalogen Compounds

<<Preparation of Organic Polyhalogen Compound 1 Dispersion>>

10 kg of the organic polyhalogen compound 1 (tribromomethanesulfonylbenzene), 10 kg of a 20% by mass aqueous solution of a modified polyvinyl alcohol POVAL MP203 available from Kuraray Co., Ltd., 0.4 kg of a 20% by mass aqueous solution of sodium triisopropylnaphthalenesulfonate, and 14 kg of water were sufficiently mixed to obtain a slurry. The slurry was transported by a diaphragm pump to a horizontal-type sand mill UVM-2 manufactured by Imex Co. which was packed with zirconia beads having an average diameter of 0.5 mm, and dispersed therein for 5 hours. Then, 0.2 g of benzoisothiazolinone sodium salt and water were added to the dispersed slurry such that the content of the organic polyhalogen compound was 26% by mass, to obtain an organic polyhalogen compound 1 dispersion. The organic polyhalogen compound 1 dispersion included organic polyhalogen compound particles having a median size of 0.41 μm and a maximum particle size of 2.0 μm or less. The organic polyhalogen compound 1 dispersion was filtrated by a polypropylene filter having a pore diameter of 10.0 μm to remove extraneous substances such as dust, and then stored.

<<Preparation of Organic Polyhalogen Compound 2 Dispersion>>

10 kg of the organic polyhalogen compound 2 (N-butyl-3-tribromomethanesulfonylbenzoamide), 20 kg of a 10% by mass aqueous solution of a modified polyvinyl alcohol POVAL MP203 available from Kuraray Co., Ltd., and 0.4 kg of a 20% by mass aqueous solution of sodium triisopropylnaphthalenesulfonate were sufficiently mixed to obtain a slurry. The slurry was transported by a diaphragm pump to a horizontal-type sand mill UVM-2 manufactured by Imex Co. which was packed with zirconia beads having an average diameter of 0.5 mm, and dispersed therein for 5 hours. Then, 0.2 g of benzoisothiazolinone sodium salt and water were added to the dispersed slurry such that the content of the organic polyhalogen compound was 30% by mass, and the liquid was maintained at 40° C. for 5 hours to obtain an organic polyhalogen compound 2 dispersion. The organic polyhalogen compound 2 dispersion included organic polyhalogen compound particles having a median size of 0.40 μm and a maximum particle size of 1.3 μm or smaller. The organic polyhalogen compound 2 dispersion was filtrated by a polypropylene filter having a pore diameter of 3.0 μm to remove extraneous substances such as dust, and then stored.

5) Preparation of Pigment-1 Dispersion

250 g of water was added to 64 g of C.I. Pigment Blue 60 and 6.4 g of “DEMOHR N” manufactured by Kao Corporation, and the mixture was sufficiently mixed to obtain a slurry. 800 grams of zirconia beads having 0.5 mm average diameter was prepared and placed in a vessel together with the slurry. The mixture was dispersed by a disperser (¼ G sand grinder mill manufactured by Aimex Co., Ltd.) for 25 hours. Water was added thereto such that a pigment concentration was 5% by mass to obtain a pigment-1 dispersion. Pigment particles contained in the pigment dispersion thus obtained had 0.21 μm average particle diameter.

6) Preparation of Aqueous Solution

Aqueous solutions were prepared form the following compounds, and then they were added.
5% by mass aqueous solution of succinimide was prepared.
5% by mass aqueous solution of 4-methylphthalic acid was prepared.
   2. Preparation of Coating Liquid
   1) Preparation of Image Forming Layer Coating Liquid

A container was kept warm at 40° C., into which 450 ml of water and gelatin were placed to dissolve the gelatin. Thereafter, an image forming layer coating liquid was prepared by adding the fatty silver dispersion, the pigment-1 dispersion, the organic polyhalogen compound-1 dispersion, the organic polyhalogen compound-2 dispersion, the compound represented by the formula (I) or (II) (indicated in Table 1), the reducing agent dispersion, the 4-methylphthalic acid aqueous solution, and sodium iodide which are obtained as described above in turns to the gelatin solution; further adding the silver halide mixed emulsion A immediately before coating; and blending sufficiently. The image forming layer coating liquid thus obtained was fed to a coating die as it was.

An amount of zirconium in the coating liquid was 0.18 mg per 1 g of silver.

2) Preparation of First Layer Coating Liquid for Surface Protective Layer

A container was kept warm at 40° C., into which 2400 ml of water and 300 g of gelatin were placed to dissolve the gelatin. After dissolving the gelatin, 60 g of 5% mass aqueous solution of sulfosuccinic acid di(2-ethylhexyl) sodium salt and 900 g of succinimide aqueous solution were added in turns to the gelatin solution, and the mixture was sufficiently stirred to prepare the first layer coating liquid.

3) Preparation of Second Layer Coating Liquid for Surface Protective Layer

A container was kept warm at 40° C., into which 2600 ml of water and 100 g of gelatin were placed to dissolve the gelatin. After dissolving the gelatin, 60 g of 5% mass aqueous solution of sulfosuccinic acid di(2-ethylhexyl) sodium salt, 300 g of succinimide aqueous solution and a matting agent (types and amounts added were indicated in Table 1) are added in turns to the gelatin solution, and the mixture was sufficiently stirred to prepare the second layer coating liquid.
A matting agent D (PMMA particles, average particle size 1.2 μm, standard deviation of particle diameter 0.5 μm)
A matting agent E (PMMA particles, average particle size 4.2 μm, standard deviation of particle diameter 2.4 μm)
A matting agent F (PMMA particles, average particle size 12 μm, standard deviation of particle diameter 4.5 μm)
   3. Fabrication of Photothermographic Materials-1 to -14

Samples of a photothermographic material were fabricated by coating simultaneously an undercoat surface, an image forming layer, a first layer of a surface protective layer, and a second layer of the surface protective layer in this order in multilayers on a side opposite to a back surface in accordance with slide bead coating method. Temperatures of the coating liquids for the image forming layer and the surface protective layer were adjusted to 37° C.

A coating amount of a fatty silver was 1.3 g/m² in a corresponding silver amount. Furthermore, the first layer and the second layer for the surface protective layer were coated in such that respective dried coating amounts of gelatin in the first layer and the second layer were 2.0 (g/m²) and 0.7 (g/m²).

Coating amounts (g/m²) of the other compounds in the image forming layer are as follows.

Gelatin (amounts described in Table 1)

Pigment (C.I. Pigment Blue 60) 0.036

Polyhalogen compound-10.10

Polyhalogen compound-2 0.34

4-Methylphthalic acid 0.08

Succinimide (amounts described in Table 1)

Sodium iodide 0.04

Reducing agent-1 0.75

Silver halide (as Ag) 0.10

The results of Bekk smoothness measured with respect to respective samples are shown in Table 1.

TABLE 1

| | | | | | | | | | Image | |
|---|---|---|---|---|---|---|---|---|---|---|
| | Matting Agent in Back | | | | Compounds represented by | | Surface Protective | | Forming | |
| | Layer | | Back Surface, | Ag/Gelatin | Formulae (I)(II) | | Second Layer | | Surface, | |
| | Matting | Coating | Bekk | Ratio | | Coating | Matting | Coating | Bekk | |
| Sample | Agent | Amount | Smoothness | (Mass | | Amount | Agent | Amount | Smoothness | |
| No. | No. | (g/m²) | (sec) | Ratio) | Type | (g/m²) | No. | (g/m²) | (sec) | Remarks |
| 1 | A | 0.1 | 100 | 0.67 | Succinimide | 0.54 | D | 0.05 | 2500 | Comparative |
| | | | | | | | | | | Example |
| 2 | A | 0.1 | 100 | 1.2 | — | — | D | 0.05 | 2500 | Comparative |
| | | | | | | | | | | Example |
| 3 | A | 0.1 | 100 | 1.2 | Succinimide | 0.54 | D | 0.05 | 2500 | The Invention |
| 4 | A | 0.1 | 100 | 1.7 | Succinimide | 0.54 | D | 0.05 | 2500 | The Invention |
| 5 | A | 0.1 | 100 | 2.1 | Succinimide | 0.54 | D | 0.05 | 2500 | The Invention |
| 6 | A | 0.1 | 100 | 2.8 | Succinimide | 0.54 | D | 0.05 | 2500 | Comparative |
| | | | | | | | | | | Example |
| 7 | C | 0.25 | 4 | 1.7 | Succinimide | 0.54 | D | 0.05 | 2500 | Comparative |
| | | | | | | | | | | Example |
| 8 | A | 0.05 | 200 | 1.7 | Succinimide | 0.54 | D | 0.05 | 2500 | The Invention |
| 9 | A | 0.03 | 300 | 1.7 | Succinimide | 0.54 | D | 0.05 | 2500 | The Invention |
| 10 | B | 0.1 | 750 | 1.7 | Succinimide | 0.54 | D | 0.05 | 2500 | Comparative |
| | | | | | | | | | | Example |
| 11 | A | 0.1 | 100 | 1.7 | Succinimide | 0.54 | F | 0.01 | 500 | Comparative |
| | | | | | | | | | | Example |
| 12 | A | 0.1 | 100 | 1.7 | Succinimide | 0.54 | E | 0.05 | 1500 | The Invention |
| 13 | A | 0.1 | 100 | 1.7 | Succinimide | 0.54 | D | 0.03 | 4000 | The Invention |
| 14 | A | 0.1 | 100 | 1.7 | Succinimide | 0.54 | D | 0.01 | Infinity | The Invention |

In the following, chemical structures of the compounds used in examples of the invention will be described. 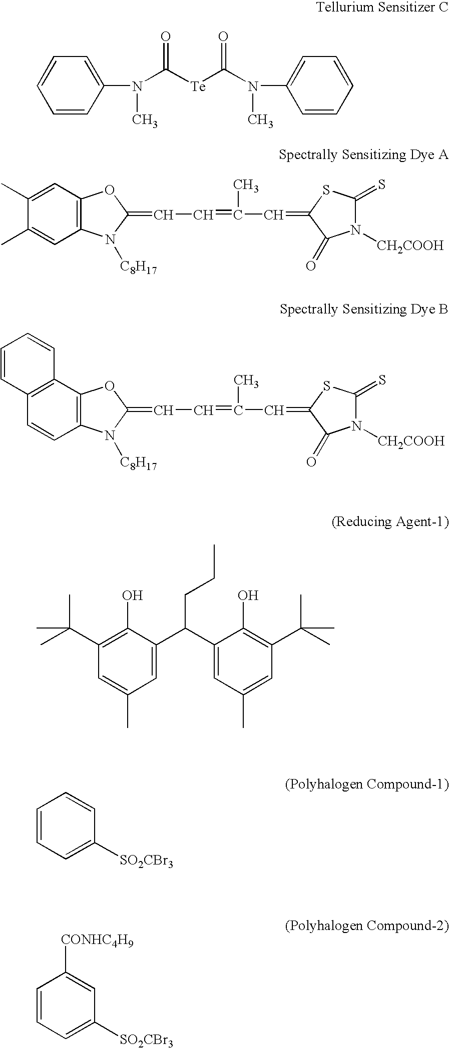
3. Evaluation of Performance
3-1. Evaluation of Coated Surface State

After exposing and developing a material so as to have a density of 1.2, a coated surface state was evaluated.

Evaluation was made by sensory evaluation using 100 m² of the material in accordance with the following standards.

a: There is neither a line, nor unevenness in density parallel to a coating direction, and the condition is good.

b: Although there is either a thin line, or slight unevenness in density parallel to a coating direction, there is no problem from the standpoint of observation of a photograph.

c: There are lines or unevenness in density parallel to a coating direction, and this is a problem from the standpoint of observation of a photograph.

3-2. Photographic Properties

1) Preparation

The obtained samples were cut into a half-cut sheet size (43 cm length×35 cm width), wrapped in the following wrapping material in an environment of 25° C. and 50% RH, and stored for 2 weeks at ordinary temperature, and then the following evaluations were made.

<Wrapping Material>

A laminate film composed of 10 μm PET, a 12 μm layer of PE, a 9 μm layer of aluminum foil, a 15 μm layer of Ny, and a 50 μm layer of polyethylene containing carbon in an amount of 3% by mass

Oxygen permeability: 0.02 ml/atm·m²·25° C.·day;

Moisture permeability: 0.10 ml/atm·m²·25° C.·day.

2) Exposure and Development of Photosensitive Material

Respective samples were exposed with a 660 nm laser and thermally developed by means of the thermal development apparatus having the drum heating section shown in FIG. 1. A conveying speed for each sample was adjusted such that a thermal developing linear speed in the thermal development section was 35 mm/sec, a temperature in the heating section was 124° C., and a heating time was 12 seconds.

3) Items of Evaluation

Fog: After the above-described exposure and development, a density in an unexposed area was designated as fog.

Sensitivity: A sensitivity when sample No. 1 was developed under the above-described conditions was designated as 100, and relative evaluation of the other samples was carried out on the basis thereof.

3-3. Evaluation of Thermal Development Cracks

Ten pieces of each of the obtained samples were stacked and sealed with the above-described wrapping material. Further, an iron plate (having a weight of 5 kg) of the same size as that of a sample was placed on the stacked samples. In this state, these samples were placed into a frame having a size of 43.5 cm×35.5 cm×5 cm height, and the samples were vibrated with a 1 cm amplitude in X, Y, and Z axial directions. The vibration was carried out for 12 minutes for each of the respective directions wherein a vibration cycle was changed continuously from 0 Hz to 50 Hz.

Thereafter, the samples were developed by means of a thermal development apparatus having the thermal development unit shown in FIG. 1, and the number of thermal development cracks that appeared on a sample was counted.

3-4. Evaluation of Development Unevenness

After exposing and developing a material so as to have a density of 1.2, density unevenness was evaluated.

Evaluation was made by sensory evaluation using 100 m² of the material in accordance with the following standards.

a: There is neither a line, nor unevenness in density in directions not parallel to a coating direction, and the condition is good.

b: Although there is either a thin line, or unevenness in density in directions not parallel to a coating direction, there is no problem from the standpoint of observation of a photograph.

c: There are lines or unevenness in density in directons not parallel to a coating direction, and this is a problem from the standpoint of observation of a photograph.

3-5. Results of Evaluation

The results obtained are indicated in Table 2.

TABLE 2

| Sample | Coated surface | Thermal Development | Photographic Properties | | Development | |
|---|---|---|---|---|---|---|
| No. | state | Cracks | Fog | Sensitivity | Unevenness | Remarks |
| 1 | b | 0 | 0.18 | 100 | c | Comparative |
| | | | | | | Example |
| 2 | b | 0 | 0.18 | 54 | b | Comparative |
| | | | | | | Example |
| 3 | b | 0 | 0.18 | 110 | b | The |
| | | | | | | Invention |
| 4 | b | 0 | 0.18 | 121 | b | The |
| | | | | | | Invention |
| 5 | b | 2 | 0.19 | 134 | b | The |
| | | | | | | Invention |
| 6 | b | 11 | 0.22 | 145 | b | Comparative |
| | | | | | | Example |
| 7 | b | 15 | 0.18 | 121 | c | Comparative |
| | | | | | | Example |
| 8 | b | 0 | 0.18 | 121 | b | The |
| | | | | | | Invention |
| 9 | b | 1 | 0.18 | 121 | b | The |
| | | | | | | Invention |
| 10 | b | 6 | 0.18 | 121 | b | Comparative |
| | | | | | | Example |
| 11 | b | 7 | 0.18 | 121 | c | Comparative |
| | | | | | | Example |
| 12 | b | 0 | 0.18 | 121 | b | The |
| | | | | | | Invention |
| 13 | b | 0 | 0.18 | 121 | b | The |
| | | | | | | Invention |
| 14 | b | 0 | 0.18 | 121 | b | The |
| | | | | | | Invention |

Photosensitive materials manufactured by the method of the invention exhibit an excellent coated surface state, very few thermal development cracks, and little development unevenness, and are an excellent photosensitive materials.

According to the present invention, a photothermographic material exhibiting little development unevenness and little trouble due to flaws at the time of thermal development, and an image forming method using the same are provided.

What is claimed is:

1. A photothermographic material, comprising a support having an image forming layer on or above one surface thereof and a non-photosensitive layer on or above the opposite surface thereof,
the image forming layer containing at least a photosensitive silver halide, a non-photosensitive organic silver salt, a reducing agent, and a binder wherein:
the binder contains 50% by mass or more of a hydrophilic binder;
a ratio of a silver amount to the hydrophilic binder in the image forming layer is 1.0 to 2.5 by mass;
a binder in the non-photosensitive layer contains 70% by mass or more of a hydrophilic binder;
the image forming layer contains at least one of compounds represented by the following formulae (I) and (II); and
a Bekk smoothness is 1000 seconds or more on an outside surface of the side having the image forming layer, while a Bekk smoothness is 5 seconds to 400 seconds on an outside surface of the side having the non-photosensitive layer: 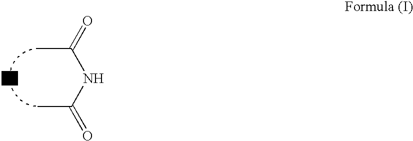
wherein Q represents an atomic group required for forming a 5- to 6-membered imide ring; 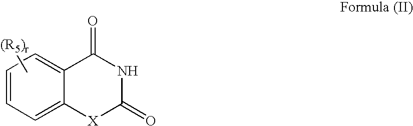
wherein R₅ represents independently a hydrogen atom, an alkyl group, a cycloalkyl group, an alkoxy group, an alkylthio group, an arylthio group, a hydroxy group, a halogen atom, or an N(R₈R₉) group wherein R₈ and R₉ represent independently a hydrogen atom, an alkyl group, an aryl group, a cycloalkyl group, an alkenyl group or a heterocyclic group; r is 0, 1, or 2; R₈ and R₉ may bond with each other to form a substituted or an unsubstituted five- to seven-membered heterocyclic ring; two R₅ groups may bond with each other to form an aromatic, heteroaromatic, alicyclic or heterocyclic fused ring; and X represents O, S, Se or N(R₆) wherein R₆ represents a hydrogen atom or an alkyl group, an aryl group, a cycloalkyl group, an alkenyl group or a heterocyclic group.

2. The photothermographic material as claimed in claim 1, further comprising:
at least one member selected from polyacrylamides or derivatives thereof.

3. The photothermographic material as claimed in claim 2, wherein:
particles of the non-photosensitive organic silver salt are formed in the presence of the at least one member selected from the polyacrylamides or the derivatives thereof.

4. The photothermographic material as claimed in claim 2, wherein:
the non-photosensitive organic silver salt is water-washed with an aqueous washing liquid containing the at least one member selected from the polyacrylamides or the derivatives thereof.

5. The photothermographic material as claimed in claim 1, wherein:
the non-photosensitive organic silver salt is in the form of nanoparticles.

6. The photothermographic material as claimed in claim 5, wherein:
the nanoparticles have an average particle size of 10 nm to 1000 nm.

7. The photothermographic material as claimed in claim 1, wherein:
there is a non-photosensitive layer as the outermost layer on the same side as the image forming layer.

8. The photothermographic material as claimed in claim 1, wherein:
the hydrophilic binder in the image forming layer is gelatin or a gelatin derivative.

9. The photothermographic material as claimed in claim 7, wherein:
a hydrophilic binder in the outermost layer is gelatin or a gelatin derivative.

10. An image forming method, comprising:
developing thermally the photothermographic material as claimed in claim 1 at a thermal developing linear speed of 20 mm/sec to 50 mm/sec.

11. The image forming method as claimed in claim 10, wherein:
the photothermographic material contains at least one member selected from polyacrylamides or the derivatives thereof.

12. The image forming method as claimed in claim 11, wherein:
particles of the non-photosensitive organic silver salt are formed in the presence of the at least one member selected from the polyacrylamides or the derivatives thereof.

13. The image forming method as claimed in claim 11, wherein:
the non-photosensitive organic silver salt is water-washed with an aqueous washing liquid containing the at least one member selected from the polyacrylamides or the derivatives thereof.

14. The image forming method as claimed in claim 10, wherein:
the non-photosensitive organic silver salt is in the form of nanoparticles.

15. The image forming method as claimed in claim 14, wherein:
the nanoparticles have an average particle size of 10 nm to 1000 nm.

16. An image forming method, comprising:
developing thermally the photothermographic material as claimed in claim 1 by a drum development method.

17. The image forming method as claimed in claim 16, wherein:
there is a non-photosensitive layer as the outermost layer on the same side as the image forming layer.

18. The image forming method as claimed in claim 16, wherein:
the hydrophilic binder in the image forming layer is gelatin or a gelatin derivative.

19. The image forming method as claimed in claim 17, wherein:
a hydrophilic binder in the outermost layer is gelatin or a gelatin derivative.

20. The image forming method as claimed in claim 16, wherein:
the photothermographic material contains at least one member selected from polyacrylamides or derivatives thereof
